(19) United States
(12) Patent Application Publication
(10) Pub. No.: US 2025/0266253 A1
(43) Pub. Date: Aug. 21, 2025

(54) EMPLOYING MASS SPECTRAL ALIGNMENT FOR STRUCTURAL MODIFICATION SITE LOCALIZATION

(71) Applicant: The Regents of the University of California, Oakland, CA (US)

(72) Inventors: Mohammad Reza Zare SHAHNEH, Riverside, CA (US); Mingxun WANG, Carlsbad, CA (US)

(21) Appl. No.: 19/054,626

(22) Filed: Feb. 14, 2025

Related U.S. Application Data
(60) Provisional application No. 63/554,686, filed on Feb. 16, 2024.

(51) Int. Cl. H01J 49/00

(52) U.S. Cl. CPC H01J 49/0036; H01J 49/0045

(57) ABSTRACT

A computer-implemented method of analyzing mass spectrometry data is described. The computer-implemented method comprises: acquiring a first data representing a mass spectrometry measurement of an unknown molecule; identifying one or more shifts in spectral peaks in the first data by comparing the first data to a second data representing a mass spectrometry measurement of a known molecule; and deriving structural information of the unknown molecule based on the one or more shifts.

### CROSS-REFERENCE TO RELATED APPLICATION(S)

This application claims priority to U.S. Application No. 63/554,686 filed Feb. 16, 2024, which is incorporated herein by reference in its entirety.

### STATEMENT REGARDING FEDERALLY SPONSORED RESEARCH

This invention was made with government support under Grant No. 5U24DK133658-02 awarded by National Institute of Health (NIH). The government has certain rights in the invention.

### TECHNICAL FIELD

The present disclosure generally relates to mass spectrometry and particularly to molecule identification using mass spectrometry.

### BACKGROUND

Tandem mass spectrometry (MS/MS) is a powerful analytical technique for identifying the structure of small molecules. However, certain inefficiencies exist in the use of such a technique for identifying molecules.

### BRIEF SUMMARY

The present document discloses techniques that may be used by embodiments to identify structural modifications in molecules based on spectrometry analysis.

In one example aspect, a method is disclosed. The method includes acquiring a first data representing a mass spectrometry measurement of an unknown molecule; identifying one or more shifts in spectral peaks in the first data by comparing with a second data representing a mass spectrometry measurement of a known molecule; and using the one or more spectral peaks to derive structural information of the unknown molecule.

In another example aspect, an apparatus comprising at least one processor is disclosed. The at least one processor is configured to execute instructions for implementing the disclosed method.

In yet another example aspect, a computer-readable storage medium (CRM) is disclosed. The CRM stores code that, upon execution, causes at least one processor to implement a disclosed method.

In another example aspect, a computer-implemented method of analyzing mass spectrometry data is disclosed. The method includes acquiring a first data representing a mass spectrometry measurement of an unknown molecule; identifying one or more shifts in spectral peaks in the first data by comparing the first data to a second data representing a mass spectrometry measurement of a known molecule; and deriving structural information of the unknown molecule based on the one or more shifts.

In another example aspect, a computer-implemented method of analyzing mass spectrometry data is disclosed. The computer-implemented method comprises: acquiring a first data representing a mass spectrometry measurement of an unknown molecule; identifying one or more shifts in spectral peaks in the first data by comparing the first data to a second data representing a mass spectrometry measurement of a known molecule; and deriving structural information of the unknown molecule based on the one or more shifts.

In another example aspect, a computer program product having code stored thereon, the code, when executed by a processor, causing the processor to implement a method is disclosed. The method comprises: identifying one or more shifts in spectral peaks in a first data representing a mass spectrometry measurement of an unknown molecule by comparing the first data to a second data representing a mass spectrometry measurement of a known molecule; determining, for each shift detected between spectral peaks of the first data and the second data, one or more potential substructures underlying the each shift; computing a distribution of likelihood scores indicating likelihood of each atom in the known molecule to be a site of structural modification in the unknown molecule; and using the distribution to localize the site of structural modification to at least one of the one or more potential substructures.

In another example aspect, a system for analyzing mass spectrometry data is disclosed. The system comprises: a spectrometer configured to obtain spectral measurement data; and one or more processors configured to receive the spectral measurement data from the spectrometer and to perform a method comprising: acquiring a first data representing a mass spectrometry measurement of an unknown molecule; identifying one or more shifts in spectral peaks in the first data by comparing the first data to a second data representing a mass spectrometry measurement of a known molecule; and deriving structural information of the unknown molecule based on the one or more shifts.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a diagram illustrating an example implementation of ModiFinder.

FIG. 2 shows diagrams providing an overview of an example ModiFinder algorithm.

FIG. 3 shows example distributions of data across different benchmarking libraries.

FIGS. 4A-4B show some example evaluation scores demonstrating the performance of ModiFinder.

FIG. 5 shows some example results obtained in a demonstration of ModiFinder.

FIG. 6 shows some example results obtained in another demonstration of ModiFinder.

FIG. 7 shows example data plots related to identifying structural modification in a compound using ModiFinder.

FIG. 8 discloses some examples of metrics used in the analysis of mass spectrometry data.

FIG. 9 shows some examples of scoring according to an embodiment.

FIGS. 10A-10D show block diagrams of an example method of spectrometry data analysis.

FIG. 11 shows some example results obtained in experiments.

FIG. 12 shows an example of an unknown molecule having a single modification site.

FIG. 13 shows some additional example results obtained in experiments.

FIG. 14 shows some additional example results obtained in experiments.

FIG. 15 shows show some example results obtained in an evaluation of the effect of collision energy on ModiFinder localization performance.

FIG. 16 shows some additional example results obtained in the evaluation of the effect of collision energy on ModiFinder localization performance.

FIG. 17 shows some example results obtained in a performance evaluation of ModiFinder.

FIG. 18 shows some example results obtained in another performance evaluation of ModiFinder.

FIG. 19 shows some additional example results obtained in another performance evaluation of ModiFinder.

FIG. 20 shows an example of a computational platform for implementing the disclosed methods.

FIG. 21 shows a flowchart of an example method of analysis of mass spectrometry data.

FIG. 22 shows a flowchart of an example method based on the disclosed technology.

### DETAILED DESCRIPTION

Tandem mass spectrometry (MS/MS) is a powerful analytical technique for identifying the structure of small molecules. However, translating the MS/MS spectra to 2D chemical structures poses a significant challenge in the field. Spectrum library matching is a key technique within the field of metabolomics to annotate known compounds. However, especially in untargeted mass spectrometry experiments, on average 87% of MS/MS spectra remain unidentified by spectral library search. To bridge this gap, modification aware spectral matching tools such as analog library search and molecular networking leverage the concept of structural propagation of known to unknown compounds-bridging between molecules with a conserved core structure but exhibit structural modifications. A key shortcoming of these approaches is that they determine which pairs of MS/MS are putatively similar in structure, but do not describe explicitly the structural difference, leaving the manual interpretation up to chemists. To tackle this shortcoming of the modification aware spectral matching tools currently used in metabolomics, the present patent document discloses a new algorithm, here termed ModiFinder, that provides side directed chemical information of chemical modifications in MS/MS matching.

Computational techniques such as MS/MS library search have enabled the reidentification of known compounds. Analog library search and molecular networking extend this identification to unknown compounds. While there have been advancements in metrics for the similarity of MS/MS spectra of structurally similar compounds, there is still a lack of automated methods to provide site specific information about structural modifications. Embodiments of ModiFinder disclosed in this patent document leverage the alignment of peaks in MS/MS spectra between structurally related known and unknown small molecules (e.g., under 2000 Da). Specifically, ModiFinder focuses on shifted MS/MS fragment peaks in the MS/MS alignment. These shifted peaks putatively represent substructures of the known molecule that contain the site of the modification. ModiFinder synthesizes this information together and scores the likelihood for each atom in the known molecule to be the modification site. Among other features and benefits, ModiFinder can effectively localize modifications which extends the capabilities of MS/MS analog searching and molecular networking to accelerate the discovery of novel compounds.

The disclosed ModiFinder approach borrows a concept from the computational challenge of site localization of post-translational modifications (PTM) of peptides in bottom-up proteomics. In PTM site localization, b/y ions that flank the modification site are used to localize the putative PTM on a linear peptide. This concept is translated to localize structural modifications of small molecules onto graphs-representing 2D molecular structures. In contrast to PTM site localization, the ability to explain the MS/MS fragmentation, while simple in peptides, is significantly more difficult in small molecules. This complexity is underscored by the plethora of methodologies, including MetFrag, MAGMa, MIDAS, and MS-Finder developed to tackle the small molecule fragmentation analysis. Even though this challenge of explaining MS/MS fragmentation is not solved, the disclosed technology builds on these methods by providing a computational approach to localize structural modifications on small molecules.

Techniques disclosed herein relate to ModiFinder, a tool that leverages the insight that flanking masses for small molecule modifications can be determined by comparing the MS/MS spectrum of an unknown structure with a modification (MS2-unknown) with the MS/MS spectrum of the unmodified known structure (MS2-known). Specifically, the peaks that are shifted by the mass of the modification between the MS2-known and MS2-unknown putatively represent substructures that contain the modification site. Conversely, peaks that do not shift in mass between MS2-known and MS2-unknown, are less likely to include the modification. Combining this information, ModiFinder computes a likelihood score for the specific site of modification across all atoms in the known compound (S-known). To accomplish this, each peak is assigned a set of possible substructures using combinatorial fragmentation. For each peak of MS2-known that has a corresponding shifted peak in MS2-unknown (signifying the fragment includes site of the modification), ModiFinder increases the likelihood scores of atoms in the assigned substructures for the shifted peaks. If the peak is unshifted, the likelihood is decreased. Furthermore, ModiFinder is able to map out the likelihood landscape for where the modification may occur across the S-known using the likelihood scores.

The present patent document also provides an evaluation of ModiFinder's performance in identifying the modification site, as well as empirical examples demonstrating how ModiFinder's computational approach can be combined with domain knowledge expertise to facilitate the discovery of new natural products. ModiFinder can be embodied using a command line tool and an interactive graphical web interface, or as a computer program product.

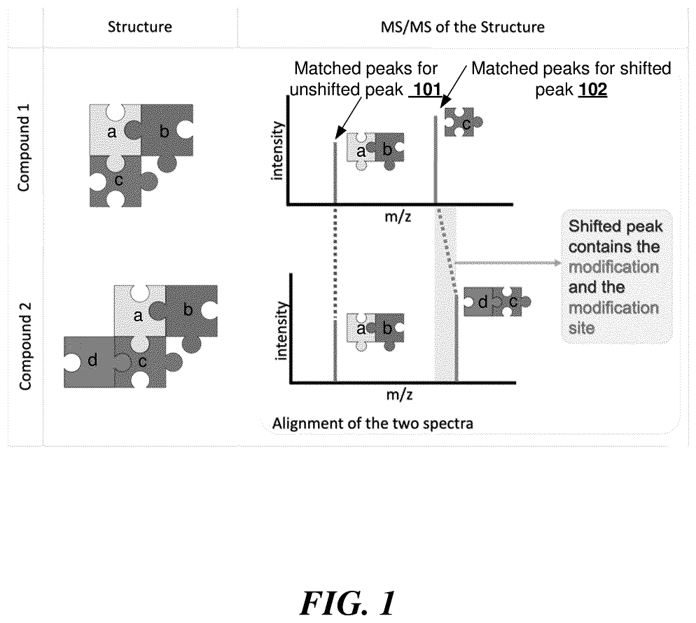

FIG. 1 shows a diagram illustrating an example implementation of ModiFinder. As shown therein, the structures of Compounds 1 and 2 are nearly identical with the exception that Compound 2 includes a modification (represented in FIG. 1 by the puzzle piece d shown on the structure of Compound 2). Using ModiFinder, the MS/MS of Compound 1 and Compound 2 are aligned and matched peaks along with their fragmentations are visualized. The matched peaks are 101 for the unshifted peak and 102 for the shifted peak. The matched shift peaks differ by the mass of the modification (the puzzle piece d) and contain the modification site (the puzzle piece c).

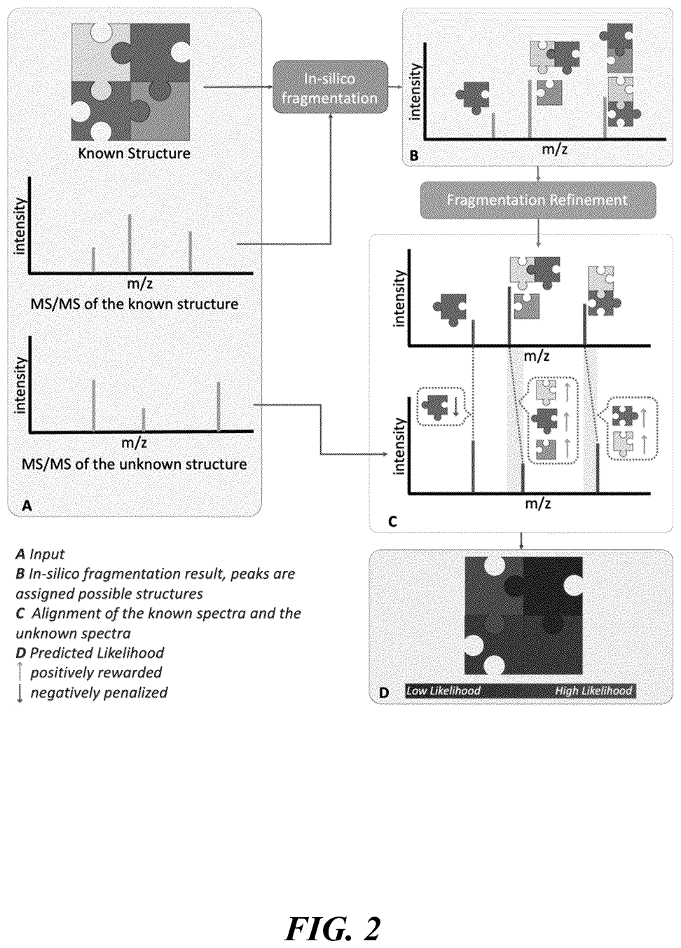

FIG. 2 shows a diagram to provide an overview of an example ModiFinder algorithm. In the description that follows, MS2-known refers to the MS/MS spectra of a known compound, S-known refers to the 2D chemical structure of the known compound, and MS2-unknown refers to the MS/MS spectra of an unknown compound. The MS/MS of known (MS2-known) and unknown (MS2-unknown) compounds and the structure of the known compound (S_known) are used as input to ModiFinder (FIG. 2, part A). ModiFinder produces a likelihood distribution of the modification site location as shown in FIG. 2, part D. The process begins with ModiFinder assigning a set of potential substructures to the peaks in the MS2-known spectrum through in-silico fragmentation of S_known (FIG. 2, part B). Specifically, in-silico fragmentation methods are used to compute potential substructure annotations for each MS/MS peak. Then, these substructures are refined by a molecular formula and with helper MS/MS with a similar structure. After in-silico fragmentation, the MS2-known and MS2-unknown are aligned to find the matching peaks in each respective spectrum, producing peaks that have shifted in mass (shifted) and those that remain unchanged (unshifted). To predict the site localization, a likelihood score is assigned to each atom, where atoms in the substructures of the shifted peaks are rewarded while the atoms in the substructures in unshifted peaks are penalized (FIG. 2, part C). Finally, the likelihood score of each atom is calculated. Some preferred embodiments of ModiFinder are directed to compounds having a mass that is within a predetermined range (e.g., between 150 and 2000 Da).

Steps in the ModiFinder algorithm are explained in further detail in the description that follows.

To perform MS/MS Alignment, ModiFinder may employ the following example approach. As a preprocessing step, all the peaks with intensities less than 1% of the base peak are removed, and the peaks are normalized to sum to a Euclidean norm of 1 to reduce noise. Then, the GNPS alignment method is utilized to identify matched peaks between the known and unknown spectrum, by accounting for the mass delta of their respective precursors. In the alignment process, the GNPS alignment method considers two types of matches: one where peaks have the same mass (non-shift), and another where peaks are offset by the difference in their precursor masses (shift). For each peak in the known compound's spectrum, the availability of both non-shift and shift peaks are examined and all possible matched candidates of each peak are considered. Out of all these possibilities, the GNPS alignment method efficiently approximates the best-scoring match. Specifically, a bipartite graph is created where the nodes represent the peaks of MS2-known and MS2-unknown. An edge is drawn between an MS2-known peak and an MS2-unknown peak under two conditions: if their difference is less than a predefined threshold, indicating an unshifted match, or if it lies within the threshold range relative to the difference in precursor masses of the known and unknown compound, indicating an unshifted peak. The weight of each edge is the product of the intensities of the corresponding peaks. The goal is to find the maximum-scoring match. A greedy algorithm is used to approximate this matching. At each step, the maximum remaining edge is selected and added to the result. Then both ends of that edge along with all the edges connected to them are removed from the graph. In some implementations, a tolerance of 40 (ppm) is adopted as the threshold used to calculate the edges.

To perform combinatorial fragmentation and refinement for substructure assignment, the peaks of MS2-known are annotated by assigning each peak a series of potential substructures using substructures generated from S_known following the MAGMa method. In short, the fragmentation of S-Known goes as follows: first, each of S-Known's heavy (non-hydrogen) atoms are removed once, each time yielding one or more substructures. Then the same process is repeated for each of the resulting substructures. The full fragmentation of the S-Known is performed in a breadth-first search traversal. The generated fragments are stored as a bitstring where each bit represents one of the heavy atoms in S-known. ModiFinder begins with the initial structure (S_known) and continues the aforementioned breadth-first fragmentation approach up to a predetermined depth. In some implementations, a maximum depth of 2 is chosen.

Once the fragmentation step is done, for each substructure, the theoretical charged-m/z is calculated and compared to each peak's m/z in the MS2-known. The maximum charge is assumed to be 1. If the theoretical m/z of a substructure falls within a specified m/z tolerance to the empirical m/z of a peak, then that substructure is assigned to that peak. In some implementations, 40 ppm is chosen as the default m/z tolerance.

ModiFinder also provides functionalities for substructure refinement by formula. In one example, predicted formulas provided by, e.g., softwares SIRIUS or BUDDY, are used to filter the possible substructures for each MS/MS peak. SIRIUS, given the spectra of a compound, generates a pool of potential candidates using the information of the MS1. Next, it evaluates the interpretability of MS/MS spectra for each candidate by constructing a fragmentation tree. The ModiFinder algorithm leverages this information by parsing the fragmentation tree and retrieving the formula assigned to each peak. This formula is then used to remove any substructure assigned to that peak with a different formula. Due to the performance complexity, SIRIUS is only computed for compounds with a precursor mass of 500 Da or less. For each compound, a mgf file is generated using the data retrieved from the MS/MS spectral library. This mgf file is then passed to a runnable script (e.g., v5.6.3 of the runnable script: github.com/boecker-lab/sirius/releases). The non-hydrogen part of the formula of each peak is then compared to the formula of all the potential substructures assigned to that peak, filtering out all the substructures that have a different formula.

BUDDY's ‘assign subformula’ function can be used to annotate formulas of fragmentation peaks. In an example implementation, the same parameter set as the ModiFinder tool is used (e.g., 40 ppm tolerance, −1.0 for the ‘dbe_cutoff’ (the default value), etc.). The provided formulas are used to refine the substructures assigned to each peak by removing substructures that have different formulas.

To refine the substructure annotations, ModiFinder can also leverage additional compounds, referred to hereinafter as helper compounds, in MS/MS libraries that exhibit structural similarities to the known compound S-Known. For example, compounds within the same MS/MS library as S-known that share identical adducts and instruments but differ from S-Known at precisely one modification site may be identified. To ensure there is no information leakage and the unknown compound is not among the helpers, any compound that possesses a precursor mass within a predetermined range (e.g., 0.5) of the precursor mass of the unknown compound is eliminated. As an example, suppose H_S_known={h_1, . . . , h_n} is the set of selected helper compounds for S-Known. For each helper compound, denoted as h_i, the same in-silico fragmentation process is performed on h i's structure to annotate h_i's peaks. Next, h_i's spectra are aligned to the MS2-Known to find matched peaks (shift and unshift). For every peak that has shifted, any substructure assigned to that peak in MS2-known that does not include the modification site between S-Known and h_i is eliminated.

In some implementations of ModiFinder, functionalities for calculating the site localization are provided. For example, a score may be computed for each atom, indicating its likelihood of being the modification site. This score, termed the “likelihood score” and represented by θ (θᵢ for atom i), aims to serve as a score that measures the amount of evidence of an atom's candidacy for being the site of modification. This scoring is performed under the assumption that there is only one modification site. Under this assumption, shifted peaks are probable hosts of the modification site. The atoms presenting in matched but unshifted peaks are penalized.

Each matched peak assigns a contribution score to each atom. ϑ_{i,j} represents the contribution score assigned to atom j by peak i. For i-th matched peak, the scores for the atoms are calculated by setting the contribution score of each atom equal to 0. Then, assuming Sᵢ is the set of all the substructures assigned peak i:

$${θ}_{i , j} = {\sum }_{s ∈ {S}_{i}} \frac{{1}_{\{ j ∈ s \}}}{\vert s \vert \times \vert {S}_{i} \vert}$$

where the 1_{{j∈s}} is the indicator function that is 1 if j-th atom exists in substructure s and 0 otherwise.

Each matched peak itself receives a clarity score that represents how informative its substructures are. For example, if a peak has one substructure assigned to it but the substructure contains all the atoms in the compound or if the peak has multiple substructures assigned to it and overall each atom appears the same number of times, then the peak is not informative and receives a low clarity score. Similarly, if the peak has few structures and they all focus on a specific and small part of the atom, then the peak is informative and receives a high clarity score. To compute this clarity score, the Shannon entropy-kit, described elsewhere, is calculated. The clarity score of the peak i, Cᵢ, is proportional to this entropy score:

$${C}_{i} = 1 - \frac{{\sum }_{i = 0}^{n} {θ}_{i , j} log ( {θ}_{i , j} )}{log ( n )}$$

where n is the total number of atoms. Finally, θⱼ is updated. If the peak is shifted, it is increased by cᵢ×ϑ_{i,j}, and if it is unshifted, θⱼ is decreased by cᵢ×ϑ_{i,j}.

After normalizing θ so that the maximum value is 1, any value below the predetermined range (e.g., 0.5) is set to 0 and, to further highlight the differences especially in the high-scoring atoms, all the values are raised to a power (e.g., power of 4) as a dynamic range adjustment. The values are normalized again to have a sum of 1.

To measure the performance of disclosed techniques and compare them to alternative approaches and baselines, an evaluation function can be employed. This evaluation function takes in the predicted likelihood array together along with the true modification site, i.e. the 2D graph structure of the known compound and the actual modification site location. The evaluation produces a score between zero and one. Scores approaching one signify more accurate predictions, while those closer to zero indicate less accurate predictions.

The γAverage_dist evaluation method, to be described in further detail in the description that follows, can be used for the evaluation.

$${S}_{Average - distance} = {\sum }_{i = 0}^{n} {θ}_{i} \times {e}^{\frac{- {d}_{i , γ}}{Φ - {d}_{i , γ}}}$$

where d_{{i, γ}} denotes the distance between the atom with index ‘i’ and true modification site γ on the 2D graph structure and denotes the diameter (greatest shortest distance between any two nodes in the graph) of the 2D graph structure. Using the diameter helps normalize the distances based on the size and structure of the compound. Normalization ensures uniformity in the evaluation metric across molecules of varying sizes. In Average_dist, the impact of each atom on the total score decreases exponentially with its distance from the actual modification site. Atoms with high predicted likelihood situated far away from the true site contribute less to the evaluation score, whereas those in closer proximity contribute more. This aspect addresses the Average_dist's capacity to account for the proximity cover. In addition, since the scores are normalized to have a sum of 1, the likelihood scores are directly proportional to each atom's relative influence. Consequently, in ambiguous scenarios where many atoms have high predicted likelihood, the relative likelihood of a single atom is diminished. This reduction, in turn, lessens their overall effect on the evaluation score and encapsulates the method's ambiguity cover.

In the description that follows, site localization baselines and other approaches within ModiFinder are disclosed. In one example, Random Choice (RC) adopts a random selection approach for designating one of the atoms as the modification site. In contrast, a second baseline, termed “Random Distribution” assigns a likelihood score |Sᵢ| to atom i, where Sᵢ˜N(0,1).

The Oracle approach is another example approach which is built on top of ModiFinder and uses the extra information of the true modification site. After ModiFinder has annotated the peaks with putative substructures using the combinatorial fragmentation and formula and helper refinements, Oracle applies an extra elimination step. Specifically, for every shifted peak of MS2-known, Oracle filters out any substructure assigned to that peak that does not contain the true modification site. Once this step is completed, all the substructures assigned to the shifted peaks are guaranteed to contain the modification site.

Another disclosed modification site approach utilizes the MS/MS fragmentation prediction property of CFM-ID, which is a tool to predict spectra based on a given molecular structure, and a baseline to compare against. This approach is only developed for evaluation as it uses the structure of the “unknown compound” which is paradoxical and impractical in real-world scenarios. It serves merely as a reference for comparison, and the ability of ModiFinder to surpass its performance, despite the latter's theoretical omniscience, further emphasizes the effectiveness of ModiFinder. The modification site approach presently disclosed is designed to use CFM-ID as a black box to find the modification site. First, using the extra information provided by the structure of the “unknown” compound, the modification substructure is calculated. Then, this modification substructure is permuted across the known structure (S_known). With each permutation, the modification is attached to an atom in S known, creating an analog to S_known and a possible candidate for the unknown compound. To attach the modified part to an atom, first the same original bond type is tried, if that does not produce a valid structure, other bond types are tried. After this step, the CFM-ID tool is used to predict spectra for each structure. To run CFM-ID, the docker container provided [https://hub.docker.com/r/wishartlab/cfmid is used with 0.001 for ‘prob_thresh’ (the default value), ‘trained_models_cfmid4.0/[M+H]+/param_output.log’ for param_file, ‘/trained models_cfmid4.0/[M+H]+/param_config.txt’ for config file. The similarity of the predicted spectra and MS2-unknown is measured using the cosine similarity score. This similarity is reported as the likelihood score of the atom corresponding to the permutation.

Some embodiments of ModiFinder include an MS/MS spectral library or database. In one example, a database used for ModiFinder evaluation may be created as follows. Initially, compounds with known 2D structures are selected from MS/MS libraries containing compounds with known structure. The following public MS/MS spectral libraries, for example, can be used to retrieve the MS/MS and structure pairs: [1-GNPS-MSMLS, 2-GNPS-NIH-NATURALPRODUCTSLIBRARY_ROUND2_POSITIVE, 3-GNPS-NIH-SMALLMOLECULEPHARMACOLOGICALLYACTIVE, and 4-BERKELEY-LAB]. In addition, the data from the TUEBINGEN-NATURAL-PRODUCT-COLLECTION can be used for the web tool performance demonstration.

For each library, every possible pair in that library is analyzed to verify its eligibility. For each pair with known structure, (i) their precursor mass is checked to be less than, e.g., 2000 Da, (ii) the difference in precursor masses is less than, e.g., 50% of the precursor mass of the smaller compound, (iii) they share the same M+H adduct, and finally, (iv) the structures are examined to differ in exactly once modification site. In a final verification step, both SMILES structures are converted to an RDKit molecule object, then the GetSubstructMatch function is called on the heavier compound's object with the smaller compound's object as input. If the smaller compound is a substructure of the larger compound, the number of edges between the atoms in the substructure set and the atoms not in the substructure set is calculated as the number of modification sites. Any pair with more than one edge is discarded.

Table I shows a table of details of example libraries used for benchmarking. Specifically, Table I shows the number of pairs (matches), the number of pairs with exactly 1 modification site, the number of pairs with [M+H]+ as adduct, and the number of pairs with at least one shifted peak is reported for each library.

TABLE I

| | | | Matches with | | Matches with |
|---|---|---|---|---|---|
| | | Number of | exactly one | | at least one |
| Short | | related pairs | modification | Matches with | annotated |
| name | library | (matches) | site | M + H adduct | shifted peak |
| lib1 | GNPS-MSMLS | 997 | 662 | 175 | 113 |
| lib2 | GNPS-NIH- | 5031 | 2391 | 1220 | 801 |
| | NATURALPRODUCTSLIBRARY_{—} | | | | |
| | ROUND2_POSITIVE | | | | |
| lib3 | GNPS-NIH- | 714 | 283 | 277 | 173 |
| | SMALLMOLECULEPHARMACOLOGICALLYACTIVE | | | | |
| lib4 | BERKELEY-LAB | 70396 | 29195 | 10353 | 6898 |
| Total | Total | 77138 | 32531 | 12025 | 7985 |

The performance of ModiFinder may be evaluated using various forms of benchmarking data and assessment criteria. In the description that follows, example techniques to evaluate ModiFinder are disclosed.

In one example evaluation of ModiFinder, pairs of structurally similar compounds with a single structural modification were used to assess the performance and accuracy of ModiFinder. These pairs were derived from the data available in the four reference MS/MS libraries shown in Table I. In aggregate, the benchmark set included 12,025 pairs with M+H adduct, that differ by a single structural modification, measured under the same experimental conditions, i.e., the same adduct and instrument. An additional filtering process was applied to these MS/MS pairs to only include pairs that have at least one shifted peak which can be explained by a substructure of the parent compound. After this filter, the majority (66% of the total pairs, 7,985 pairs) of the pairs remain.

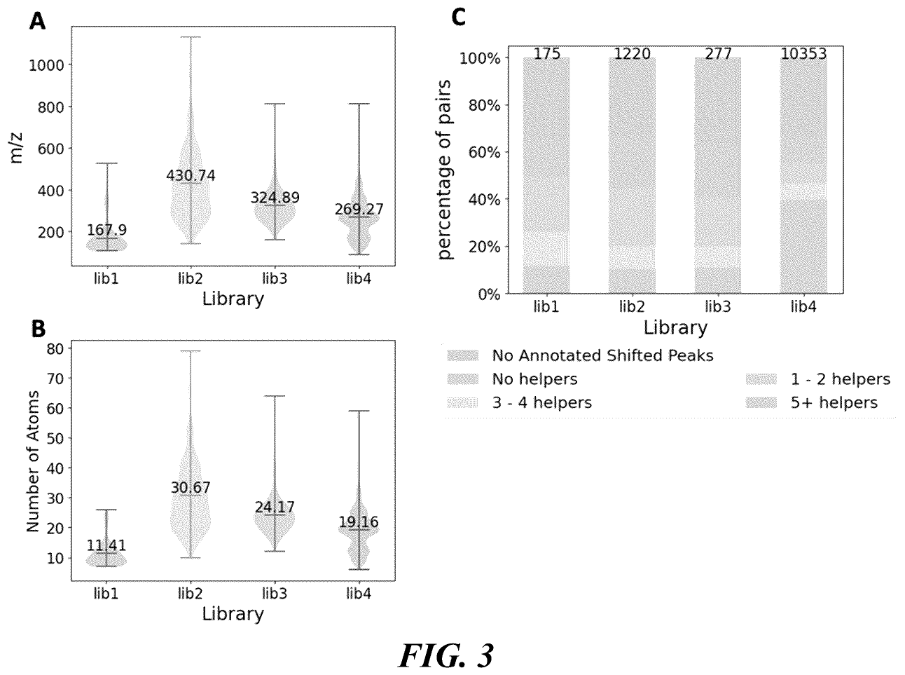

FIG. 3 shows example distributions of data in the benchmarking libraries. FIG. 3, part A shows the average and the distribution of m/z over the different libraries for pairs with at least one annotated shifted peak. It can be gleaned from the data of FIG. 3, part A that the majority (66% of the total pairs, 7,985 pairs) of the pairs remain. FIG. 3, part B shows the average and the distribution of the number of atoms in the compounds for each benchmark library for pairs with at least one annotated shifted peak. FIG. 3, part C shows, for each library, the percentage of the pair of spectra with no annotated shifted peak. The rest of the pairs are categorized and shown based on their number of helpers, as illustrated in FIG. 3, part C. The majority of pairs have at least one shifted peak.

In an example assessment of the effectiveness of ModiFinder, any evaluation metric introduced needs to balances the dual criteria: proximity cover and ambiguity cover. Proximity cover assesses the distribution of likelihood scores relative to the true modification site and examines whether the high-scoring atoms are in close proximity to the actual modification site. Ambiguity cover evaluates the entropy of the prediction array and its informativeness. For instance, an array where most atoms have the same high-score exhibits high ambiguity and may not be helpful for localization.

In one example assessment, several baseline metrics were considered but exhibited specific weaknesses. For example, if an evaluation function only checks if an algorithm assigns the highest score to the true modification site, an algorithm that always assigns the same score to all the atoms will achieve the best result, demonstrating weakness in ambiguity cover. In the example assessment, an Average-distance evaluation metric that balances the proximity cover and ambiguity cover was introduced. Throughout this patent document, “Average-distance” may be referred to as “Evaluation Score”.

In an example demonstration showing how ModiFinder can outperform a baseline, three versions of the ModiFinder method were introduced. First, was the basic version of ModiFinder (MF-N). Second, was the refined version of ModiFinder (MF-R) that utilizes molecular formula filtration and substructure ambiguity refinement utilizing structurally related helper MS/MS spectra, as previously discussed in connection to substructure refinement by formula and refinement by helpers. Third, was an Oracle Method of ModiFinder (MF-O) that has knowledge of the true modification site to provide an approximate upper bound of ModiFinder performance. This is achieved by simulating the ability to reduce the ambiguity of substructure assignments to the MS/MS peaks and by eliminating substructures that do not contain the modification site in shifted MS/MS peaks. Also evaluated during the demonstration was the site localization performance on two random baselines: Random choice (RC) and Random Distribution (RD). An alternative in silico prediction approach, which utilizes MS/MS fragmentation prediction of CFM-ID, was also implemented.

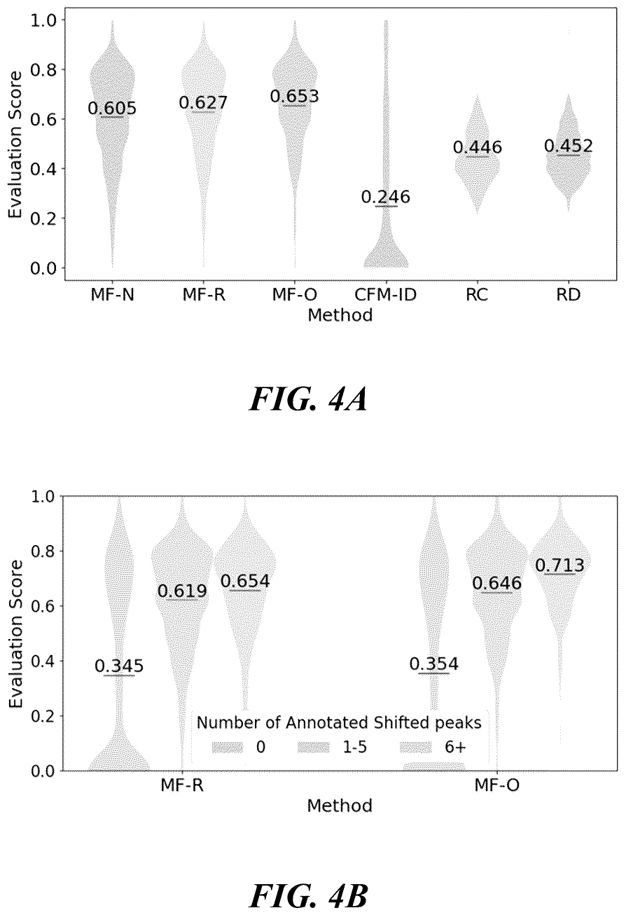

Some results obtained from the example demonstration are shown in FIGS. 4A-B. FIG. 4A shows evaluation scores across pairs in all the libraries for different methods (i.e., MF-N, MF-R, MF-O, CFM-ID, RC, and RD) where there is at least one shifted peak. FIG. 4B shows evaluation scores across pairs in all libraries for MF-O and MF-R based on the number of annotated shifted peaks. ModiFinder's performance (MF-R in FIG. 4A) lies above the random baselines (RC and RD) and the CFM-ID approach, and below the Oracle (MF-O). Specifically, it can be demonstrated from FIG. 4A that the MF-R when compared to RC and RD baselines shows an average Evaluation Score increase of 0.181 and 0.175, respectively, across all MS/MS pairs. Moreover, MF-R outperforms these baselines in 79% and 78% percent of benchmark pairs. In comparison, the MF-O version of ModiFinder outperforms the RC and RD in 85% of benchmark pairs and shows an average increase of 0.207 and 0.201, respectively. MF-R exhibits enhanced performance not only relative to random baseline comparisons but also over the CFM-ID based alternative approach evidenced by an increment of 0.381 in the average evaluation score (FIG. 4A). Surprisingly, it is observed that CFM-ID performs worse than RC and RD. This is because when simulating all regio-isomers, the resulting simulated MS/MS spectra were highly similar. This resulted in a nearly uniform likelihood distribution across all atoms, which was penalized in the “Ambiguity Cover” evaluation dimension.

It should be noted that the gap in performance between MF-R and other baselines is greatest in lib4, which constitutes the majority of the database and might introduce a bias in the result. Nevertheless, MF-R maintains a clear advantage over the baseline across all the libraries. Of the specific cases where MF-R does not outperform the RC and RD, manual analysis indicates in the majority of cases, this is because of a lack of shifted fragmentation peaks and or incomplete in silico substructure explanation of the MS/MS peaks.

With decreasing ambiguity of substructure assignments to MS/MS peaks, an increased site localization performance was observed. It was also observed that MF-R improves upon MF-N, 0.627 vs 0.605 evaluation score respectively and MF-O, with the lowest ambiguity, further increases performance to 0.653 (FIG. 4A).

The results of FIGS. 4A-B highlight the significance of annotated shifted peaks in the identification of the modification site. It can be observed from FIG. 4B that MS/MS spectrum pairs featuring at least one shifted peak exhibit higher evaluation scores compared to those without any shifted peaks. It was also found that when there is an increase in the number of shifted peaks, the measured performance of MF-R and MF-O increases (FIG. 4B). One hypothesis is that the increase in shifted peaks potentially enriches the diversity of potential substructures, each MS/MS peak focusing on different segments of the compound. This diversity may reduce the overlap among substructures, thereby refining the precision in pinpointing the modification's location. MF-O utilizes the shifted peaks more efficiently than the MF-R as it can remove the ambiguity introduced by more annotations on the extra shifted peaks.

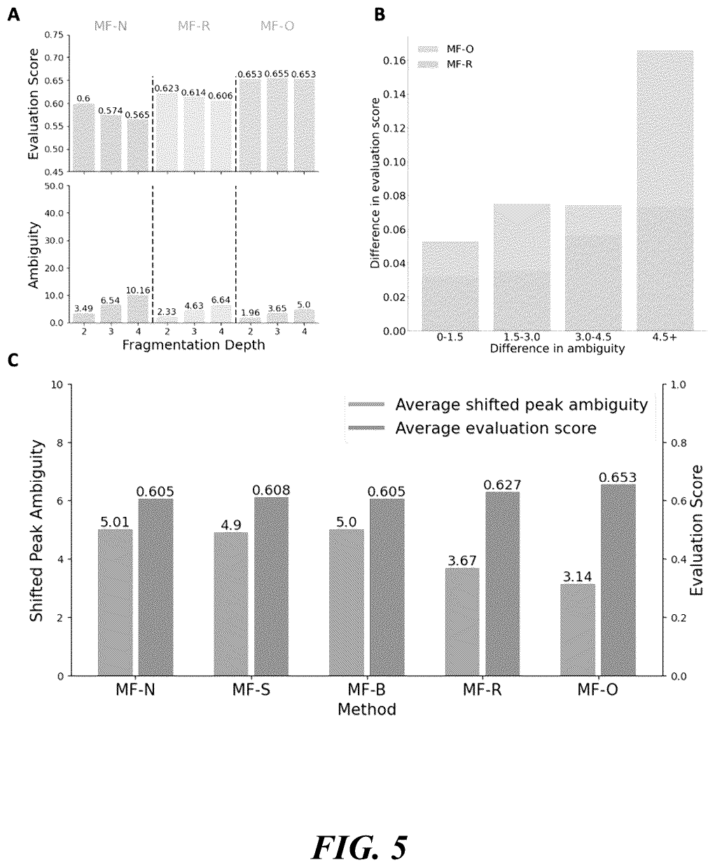

One of the key steps of ModiFinder is substructure annotation of MS/MS fragment peaks. In some example embodiments, ModiFinder utilizes combinatorial fragmentation, e.g., MAGMa software, to generate a set of potential fragmentation substructures for every MS/MS peak. Varying the fragmentation depth, e.g., from two to four, modulates the site localization performance. FIG. 5, part A shows an example data plot to demonstrate the impact of fragmentation depth on MF-N, MF-R, and MF-O. In FIG. 5, part A, an increase in performance with MF-O is observed as the fragmentation depth increases. This increase in performance can be attributed to the introduction of more substructures to the peaks, revealing the true substructure, especially for the peaks that were previously unannotated. Benchmark datasets show a 19% increase in the number of annotated shifted peaks when increasing fragmentation depth from two to four. While this increased explanation benefited MF-O, at higher fragmentation depths MF-R performance decreases. This is due to increased substructure ambiguity (average number of annotations assigned to each shifted peak). MF-O can counteract the increased ambiguity by utilizing the true fragmentation site to filter out substructures that do not benefit the localization. On the other hand, both the MF-R and MF-N are unable to filter incorrect substructures, leading to a loss of focus on the true modification site. Given the performance differences, a fragmentation depth of 2 was chosen as the default value for MF-R. However, it is anticipated that the optimal fragmentation depth might increase with enhancements in substructure assignments to MS/MS peaks.

FIG. 5, part B shows an example data plot demonstrating correlation of ambiguity and evaluation scores at the pairwise level over pairs in all libraries. The evaluation score improvement from the unrefined ModiFinder (MF-N) for MF-O and MF-R based on the ambiguity reduction (difference in ambiguity) is shown in FIG. 5, part B. As the ambiguity difference increases, i.e., structural annotation becomes increasingly less ambiguous, the evaluation score difference increases.

FIG. 5, part C shows an example data plot which provides a comparison of average ambiguity and average evaluation score across different settings of ModiFinder and Oracle for pairs in all datasets. Methods that yield lower ambiguity correspondingly achieve higher evaluation scores.

MF-N calculates the likelihood scores using annotations derived from MAGMa. Upon refining the molecular formula with SIRIUS (MF-S) or Buddy (MF-B) applied to MF-N, there was a decrease in ambiguity by 0.11 and 0.01, respectively, as shown in FIG. 5, part C. This resulted in minimal improvements to the site localization evaluation score also shown in FIG. 5, part C. A larger magnitude reduction in MS/MS peak annotation ambiguity (reduction of 1.34) when helper compounds are utilized (MF-R) was observed. The most significant reduction in ambiguity (1.87) was observed, predictably, with the oracle (MF-O) (FIG. 5, part C). There is a noticeable correlation between the decrease in annotation ambiguity and the improvement in evaluation scores; specifically, when the ambiguity of shifted peaks is reduced through refinements or the oracle's knowledge, there is a corresponding increase in the evaluation score in FIG. 5, part C. Additionally, the impact of ambiguity reduction was analyzed on a pair-by-pair basis. By categorizing pairs of MS/MS spectra based on the extent of ambiguity reduction, it was found that larger decreases in ambiguity corresponded to more significant improvements in site localization evaluation scores (FIG. 5, part B). FIG. 5, part B further indicates that for a comparable reduction in ambiguity, the Oracle, on average, achieves greater improvements. This outcome is anticipated, as the oracle's role extends beyond merely reducing ambiguity and skews the distribution of unambiguous peaks towards the actual modification site by eliminating substructures that do not contain the modification site.

Another example embodiment of the disclosed technology relates to a ModiFinder web user interface. An interactive analysis platform was developed to facilitate the utilization and refinement of site localization which can be employed, e.g., by chemists and mass spectrometrists using ModiFinder. Although the integration of helper compounds and formula refinement significantly enhances ModiFinder performance, these techniques do not fully eliminate substructure annotation ambiguity. Therefore, the disclosed interface enables expert users to apply their domain knowledge to eliminate incorrect substructures for each MS/MS fragment. The web interface then synthesizes this user input (or multiple user refinements) with ModiFinder to produce a refined likelihood distribution.

As proof of principle, the web interface of ModiFinder and domain expertise were employed to solve the location of structural modifications of two natural products: Kirromycin and Naphthomycin B, two structurally complex natural products. These compounds were selected as they exhibited high structural complexity and there existed a large diversity of structural analogs that remain unidentified.

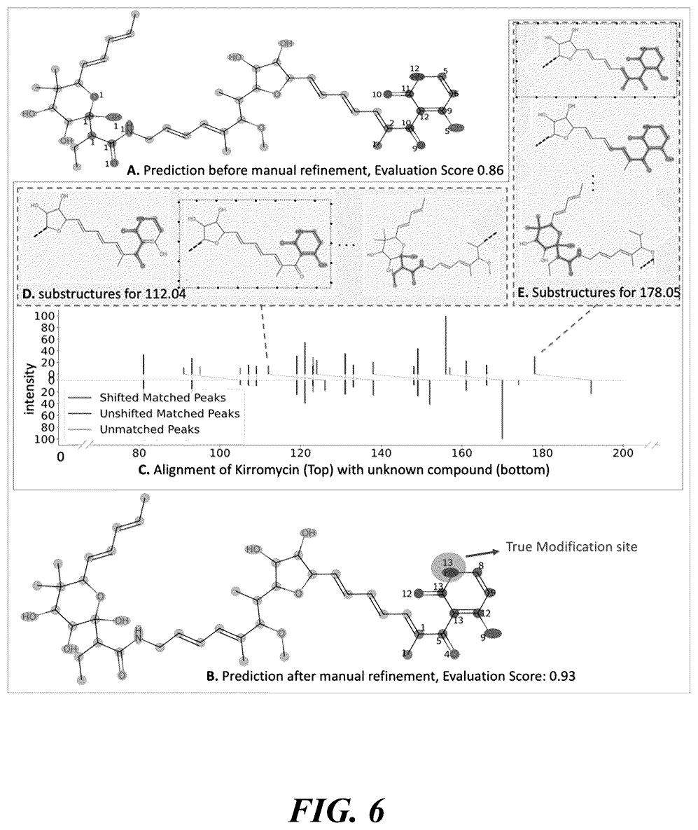

FIG. 6 shows example results which were obtained and demonstrate the ability to localize the N-methylation of Kirromycin that leads to its derivative Goldinodox. It can be seen from FIG. 6 that for the pair of Kirromycin and an unknown compound (Goldinodox), the initial prediction is improved by manually selecting the likely substructures for peak 112.04 m/z and 178.05 m/z improving the evaluation score from 0.86 to 0.93. Specifically, FIG. 6, part A shows ModiFinder prediction before the refinement. FIG. 6, part B shows ModiFinder prediction after the refinement, where the true modification site is highlighted by the green circle. FIG. 6, part C shows the alignment of Kirromycin and the unknown compound. The peaks of Kirromycin are shown at the top and the peaks of the unknown compound are shown at the bottom, where shifted and unshifted peaks are highlighted. FIGS. 6, parts D-E show the substructures assigned to peaks with 112.04 m/z and 178.05 m/z, due to the high number of substructures (ambiguity) only three substructures are shown. The green dotted box shows the substructure manually selected based on expert understanding of gas phase fragmentation.

In ModiFinder's initial prediction shown in FIG. 6, part A, the true modification site was among the highest scoring. However, these existed two regions on the structure with non-zero likelihood scores as seen in FIG. 6, part A. MF-R computationally assigned seven possible substructures to each of the 112.04 m/z and 178.05 m/z peaks. By taking the polarization of the neighboring bonds to the carbonyl as well as the numbers of (single) bonds to be broken into account, domain experts were able to limit the substructures assigned to the peak 112.04 m/z to one (visualized by the dotted rectangle in FIG. 6 part D and FIG. 6, part E). Similarly, the set of substructures assigned to the 178.05 m/z peak was also manually reduced to one, i.e. the unlikely events of double bond breaking, forming of terminal amides through alkene loss, or alkene side chain methyl cleavage were eliminated. This reduction in ambiguity improved the site localization of the methylation and increased the evaluation score from 0.86 to 0.93.

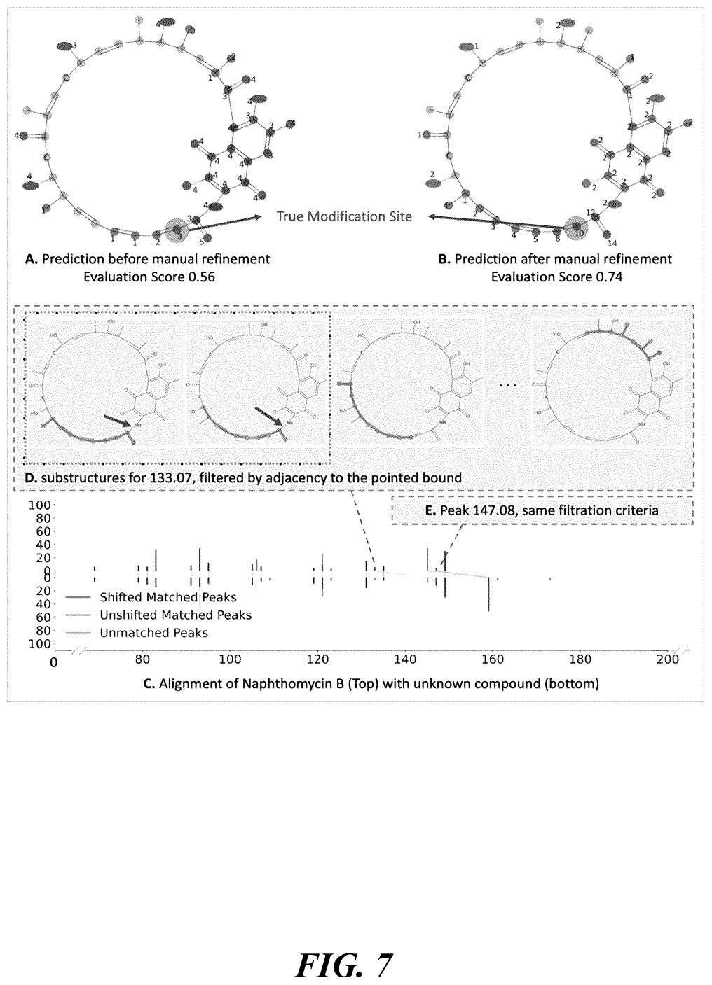

FIG. 7 shows example data plots related to identifying structural modification in Naphthomycin B. The results of FIG. 7 demonstrate that combining domain knowledge with ModiFinder's user interface can improve the modification site prediction. For the pair of Naphthomycin B and an unknown compound (Naphthomycin A), the initial prediction is improved by manually eliminating the unlikely substructures for peaks 133.07 m/z and 147.08 m/z, improving the evaluation score from 0.56 to 0.74. FIG. 7, part A and B show ModiFinder prediction before (FIG. 7, part A) and after the refinement (FIG. 7, part B), where the modification site is highlighted by the green circle. FIG. 7, part C shows the alignment of Naphthomycin B and the unknown compound. In FIG. 7, part C, the peaks of Naphthomycin B are shown at the top and the peaks of the unknown compound are shown at the bottom, where shifted and unshifted peaks are shown. FIG. 7, part D shows the substructures assigned to peak with 133.07 m/z, due to the abundance of substructures (ambiguity) only four substructures are shown. The green dotted box shows the substructures manually selected based on expert understanding of gas phase fragmentation specific to amide bonds, which are indicated by green arrows. FIG. 7, part E shows the same filtration applied to the peak with 147.08 m/z.

FIGS. 7, parts A-B demonstrate the methylation of Naphthomycin B. The specific challenge of Naphthomycin B, is due to the cyclic 2D structure, which causes MS/MS fragments (133.07 m/z and 147.08 m/z) to be ambiguous between multiple substructures around the 2D cycle (FIG. 7, part D). This ambiguity leads to 24 high scoring sites (atoms) across the compound. In the case of Naphthomycin B, taking into account the likely gas phase fragmentation site at the amide bond, the substructure ambiguity for 133.07 m/z and 147.08 m/z decreased from 27 and 40 substructures to 2 substructures each. This resulted in a decrease of 24 high scoring modification sites to two high scoring modification sites above the true modification site. Further, the site localization was narrowed to a single likelihood region for the potential methyl-carrying site. This manual refinement improved the evaluation score from 0.56 to 0.74. However, ModiFinder, even given this ambiguity reduction, reported the highest likelihood two atoms away from the true site. The small number of shifted peaks likely limited the ability to localize to a specific site, but the ambiguity reduction provided by domain experts enabled ModiFinder to reach the limits of localization with the given MS/MS fragmentation.

Among other features and benefits, ModiFinder can be implemented to address the computational challenge of site localization of modifications in small molecules. As demonstrated in the benchmarking results previously discussed, ModiFinder and its refinements are able to outperform random baselines and in silico prediction alternative strategies. Promisingly, it has also been demonstrated in the present patent document that due to refinements, ModiFinder makes significant progress to approach the performance of an Oracle method, that is an estimate of the upper bound on performance. In some implementations, ModiFinder may be embodied as a web interface that enables an expert user to input their knowledge. Example results described in this patent document demonstrate that such input can enable the performance of ModiFinder to be brought closer to the Oracle performance and in some cases could even exceed the Oracle.

Although the present patent document provides some example applications in the natural product field, modification site localization techniques based on the disclosed technology may find broader applications in other communities that utilize small molecule untargeted mass spectrometry, e.g. toxicology, pharmacology, metabolism, exposomics, drug discovery, and chemical biology, among others.

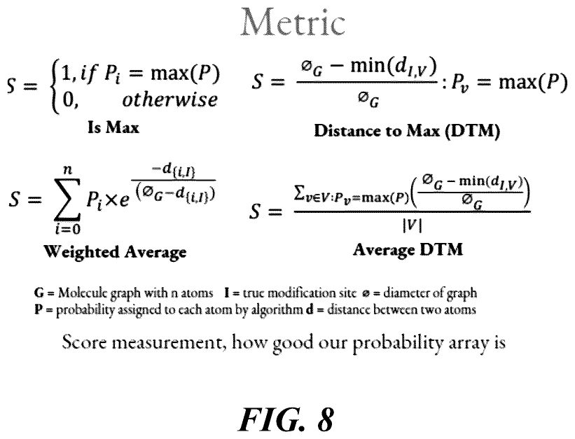

FIG. 8 discloses some examples of metrics used in the analysis of mass spectrometry data. The metrics shown in FIG. 8 may be utilized, for example, to determine a score measurement.

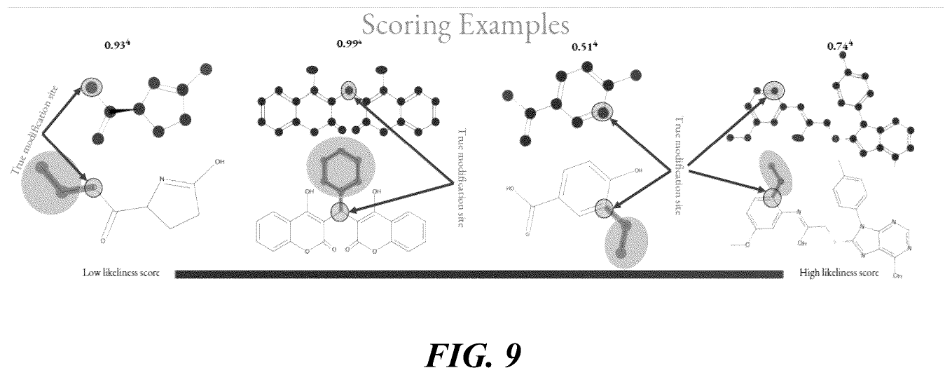

FIG. 9 depicts some examples of scoring in accordance with implementations of the disclosed technology. In FIG. 9, various hypotheses for localized structural changes along with a probability score associated therewith are depicted.

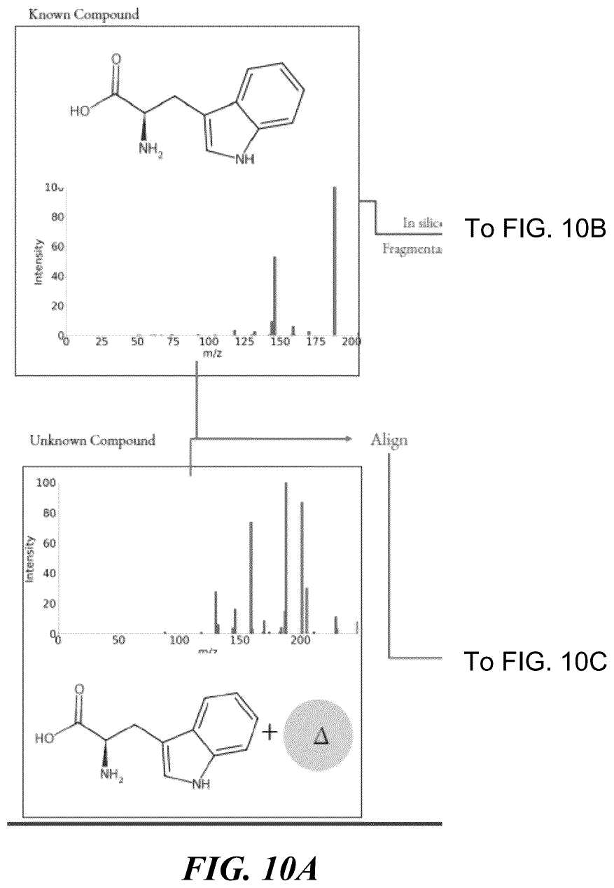

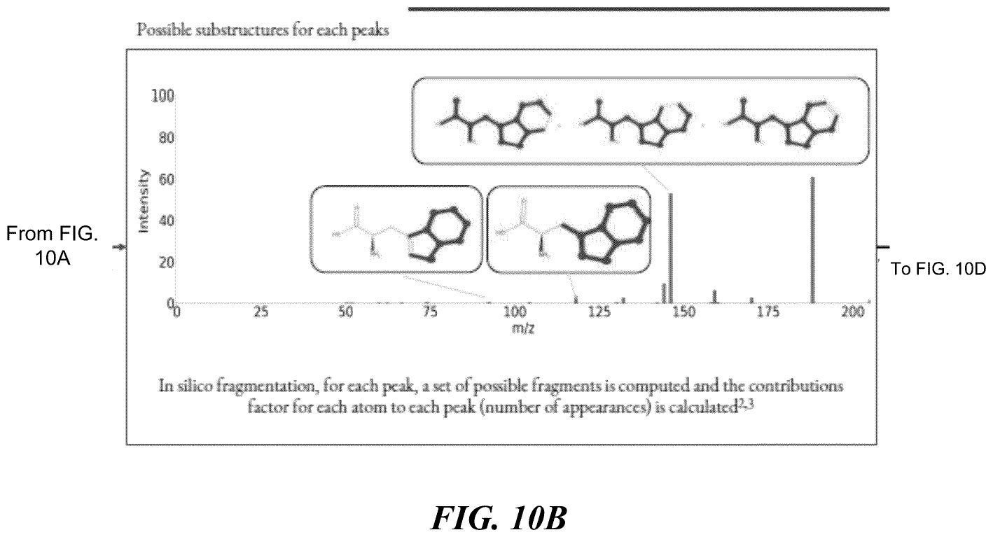

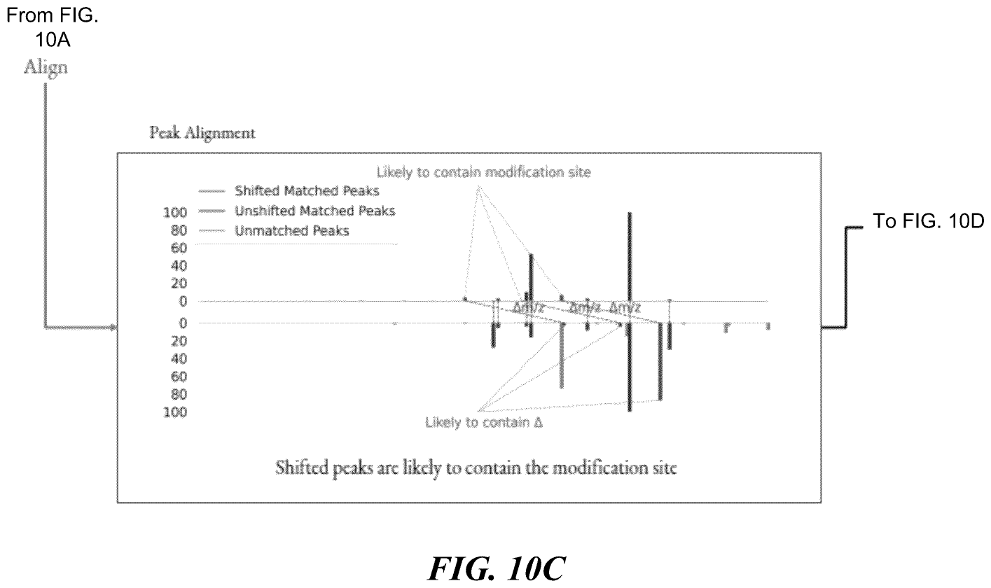

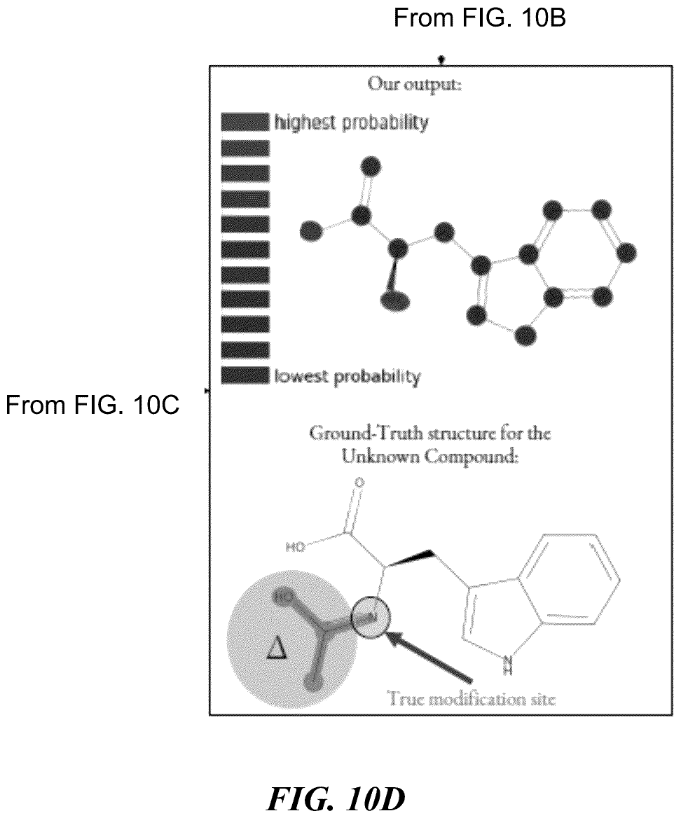

FIGS. 10A-D are block diagrams of an example method of spectrometry data analysis.

FIG. 10A depicts a known compound (top) and an unknown compound (bottom). FIG. 10B depicts possible structures for each peak, estimated by analyzing data the compound in FIG. 10A (by in silico fragmentation). FIG. 10C shows results of peak alignment performed between the spectra of compounds in FIG. 10A. FIG. 10D (top) shows a probabilistic estimate based on the disclosed algorithm including the ground truth structure used for determining the unknown molecule.

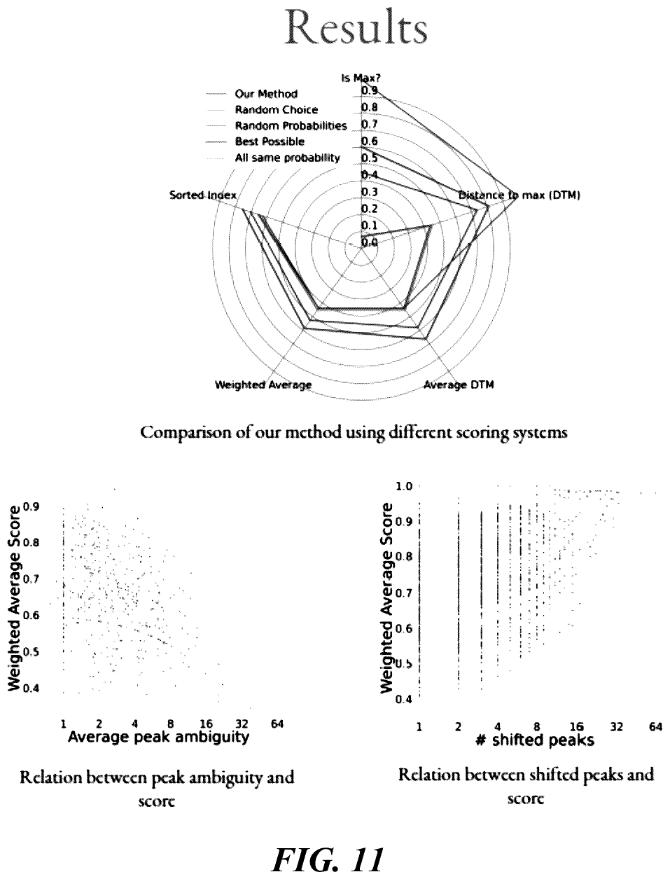

FIG. 11 depicts some example results obtained in experiments. FIG. 11 (left) illustrates the relationship between peak ambiguity and score. FIG. 11 (right) illustrates the relationship between shifted peaks and score.

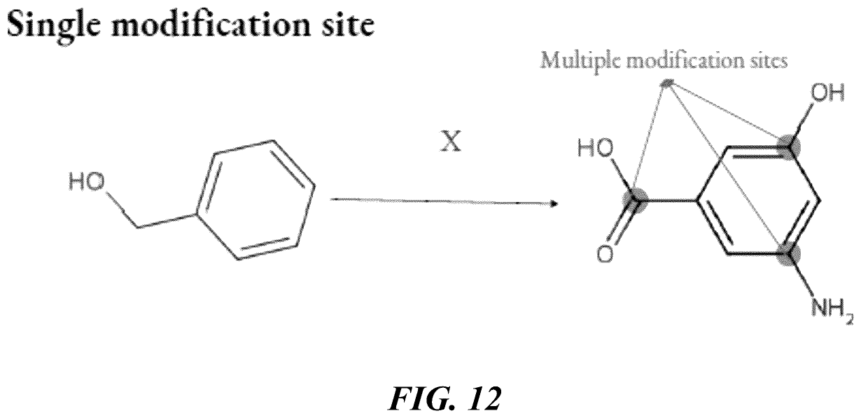

FIG. 12 shows an example of an unknown molecule having a single modification site. This depiction highlights a technical problem in which multiple structures are mapped to each peak in the MS/MS spectrum, covering a significant portion of the atoms, resulting in equal probabilities assigned to the atoms. In such cases, additional measurements may be performed.

In some embodiments, a method may include: taking measurements of an unknown molecule, using peak movement between spectra of the unknown molecule and a known molecule to estimate a localization where a modification to the known molecule may have happened, and obtaining one or more candidate molecule structures for the unknown molecule along with a corresponding confidence level (probability number).

In another method, a new compound may be detected using mass spectrometry readings in which a match is attempted against a library of known spectra of known molecules. Shifts are detected by aligning peaks in the spectra. The known molecule is annotated based on the shifts based on a predicated localization of where the unknown molecule may be different than the known molecule. This process may be repeated for each shifted peak, thereby identifying all differences between known and unknown molecules.

In one advantageous aspect, the above-methods may be used for figuring out specificity of synthetic chemistry reactions, to study and evolve enzymes based on estimated localization differences.

In one example study, it was investigated how incorporating MS/MS spectra from multiple collision energies and mass spectrometry adducts can enhance ModiFinder's localization accuracy. Using a dataset from Agilent Technologies comprising 2,150 data-rich compounds-five times larger than previously available datasets—the impact of complementary spectral information was evaluated. As will be explained in further detail below, the results show that combining spectra from different adducts and collision energies can expand ModiFinder's localization abilities to more compounds and improve the overall performance.

Tandem mass spectrometry (MS/MS) is a robust technique for identifying small molecule structures. However, converting MS/MS spectra into accurate 2D chemical structures remains a significant challenge. While methods like spectrum library matching have proved to be a powerful approach in compound identification, on average 87% of MS/MS spectra from untargeted mass spectrometry experiments remain unidentifiable by library search. The ModiFinder approach reframes the identification challenge of identifying putative new analogs to the computational problem of localizing chemical transformation on known molecules. By utilizing MS/MS data of structurally similar compounds, ModiFinder has been shown to be able to produce a prediction of the likelihood of the site of a structural modification. In the example study presently disclosed, two key areas related to the ModiFinder approach were studied: first, too few MS/MS peaks and second, the ambiguity of MS/MS fragmentation annotation. In the example study, the first was addressed by investigating how increases in the number and potential complementarity of MS/MS peaks can enhance ModiFinder performance. Specifically, it was explored how the incorporation of different collision energies and mass spectrometry adducts enhance ModiFinder localization performance. ModiFinder was analyzed across multiple collision energies and adduct types. Merging methods are provided that integrate this information into an ensemble learning framework and assess the performance.

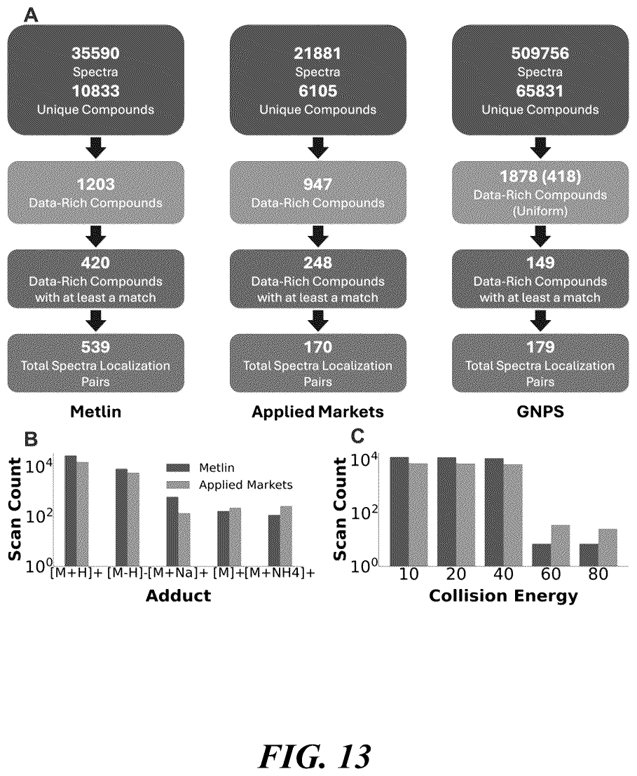

In the example study, several extensions to ModiFinder that utilize domain-specific insights are disclosed. Specifically, it was explored how employing multiple collision energies and combining multiple adducts effects localization with ModiFinder. This investigation is possible due to the comprehensive nature of MS/MS libraries utilized in the study. FIG. 13, part A shows the number of scans in each dataset, the number of unique compounds, and the number of Data-Rich unique compounds (Compounds with scans having both [M+H]+ and [M−H]− adduct and collision energy 10, 20, 40 V). FIG. 13, part A also shows that the GNPS dataset, as one of the biggest public datasets, contains 418 unique compounds that have scans available for both [M+H] and [M−H] adducts and three distinct collision energies in comparison to 1203 and 947 (2150) unique compounds analyzed in the study. FIG. 13, parts B-C shows the distribution of adducts and collision energies in the datasets, respectively.

In the example study, the results were evaluated on two datasets provided by Agilent Technologies, namely Metlin, and Applied Markets comprising 10833, 6105 unique compounds from the Agilent MS/MS library, called Agilent library (FIG. 13). The MS/MS dataset includes MS/MS with various collision energies, but was limited in the example study to 10, 20, and 40 V collision energies as they account for more than 98% of the dataset (FIG. 13, part C). Although 18 unique adducts are present, the analysis was limited to [M+H] and [M−H], which account for more than 96% of the dataset (FIG. 13, part C). The compounds that have all the 6 scans—both adducts of interest ([M+H] and [M−H]) and the 3 collision energies (10, 20, and 40V)—are referred to hereinafter as the “Data-Rich” Compounds. There are 1203 and 947 Data-Rich compounds in Metlin and Applied Markets respectively. From these Data-Rich Compounds, pairs of compounds differing by exactly one modification site were identified, 539 (170) pairs were detected spanning 420 (248) compounds for the Metlin (Applied Markets) dataset. In comparison, there are 179 pairs available in GNPS.

Findings indicate that increasing collision energies enhance ModiFinder's ability to analyze pairs previously unmanageable. However, the benefits plateau beyond a certain threshold due to increased ambiguity. Additionally, ModiFinder's performance on [M−H] ion pairs is generally inferior to that on [M+H] pairs, which may be attributed to [M−H] ion pairs being more challenging to annotate. Lastly, employing an ensemble approach combining [M−H] and [M+H] substantially improves the pool of potential pairs ModiFinder can perform confidently.

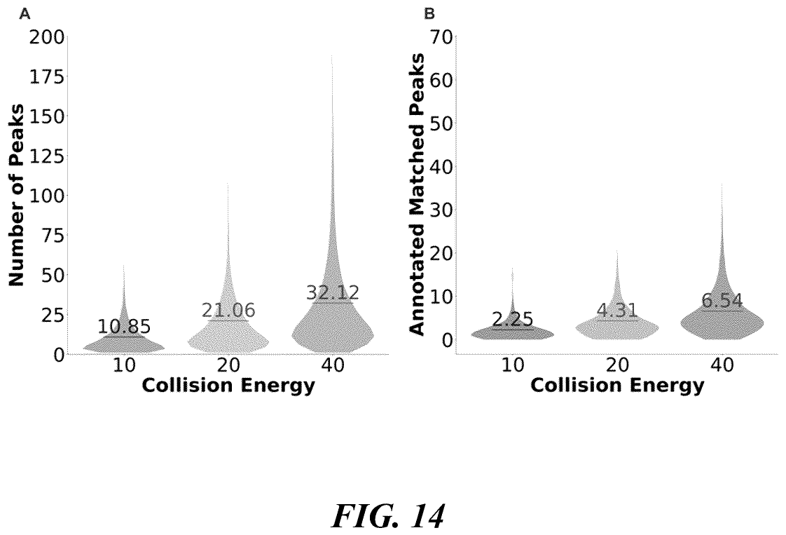

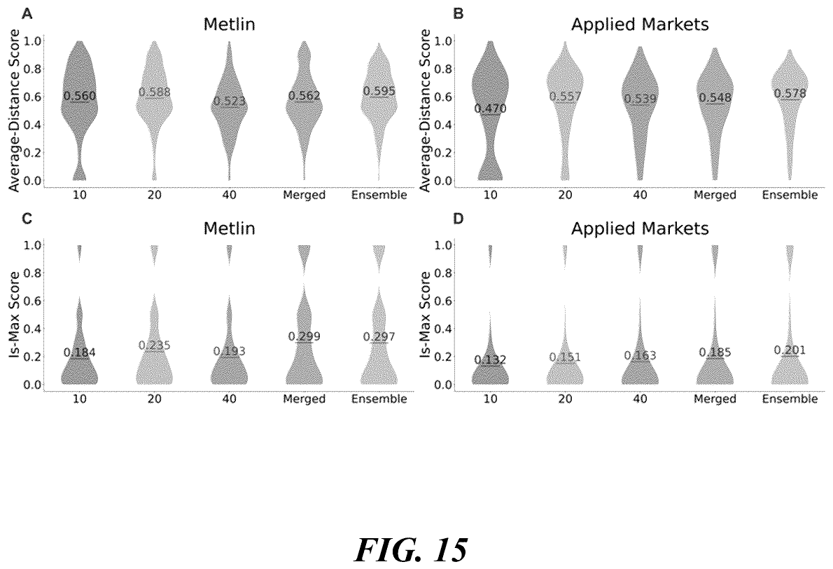

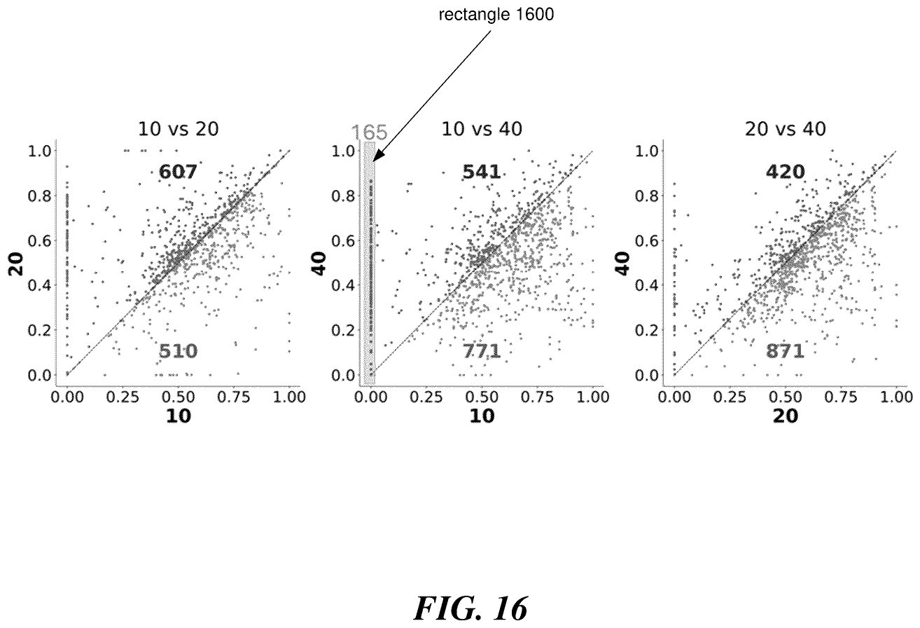

The effect of collision energy on ModiFinder localization performance was evaluated in the example study. FIG. 14 shows the distribution of peaks and annotated peaks with respect to collision energy in the example study. The number of peaks and annotated peaks for each collision energy for the two datasets were combined. Broadly, FIG. 14 shows that as collision energy increases, the number of peaks rises, leading to an increased number of matched peaks and the number of annotated matched peaks. However, the number of annotated peaks alone is not enough of a measure for the performance of ModiFinder. FIG. 15 shows ModiFinder results for different collision energies across different datasets. As illustrated in FIG. 15, parts A-B, the data shows that the Collision energy 20V scores higher than both 10V and 40V on both Agilent datasets when using the Average-Distance metric. FIG. 15, parts C-D show that while the Average-Distance metric does not show significant improvements between 20V and Merged or Ensemble, the Is-Max metric shows significant improvement from Ensemble in comparison to other collision energies and the merged method. FIG. 16 shows a pairwise comparison of ModiFinder result for different collision energies. Each subgraph shows a scatter plot where the performance of ModiFinder for each match for the respective collision energy is calculated using the average distance metric. To show the effect of increasing collision energy, the number of matches that ModiFinder couldn't provide any prediction on collision energy 10V, but did provide a prediction on collision energy 40V is highlighted with rectangle 1600 (165 matches). By increasing the collision energy from 10V to 40V, it was found that 165 compounds which could not localize a modification in 10V, were now localizing significantly better (FIG. 16). Moreover, FIG. 16 shows that no specific collision energy consistently yields better results with ModiFinder, though experiments show 20V performs the best on average (FIG. 13).

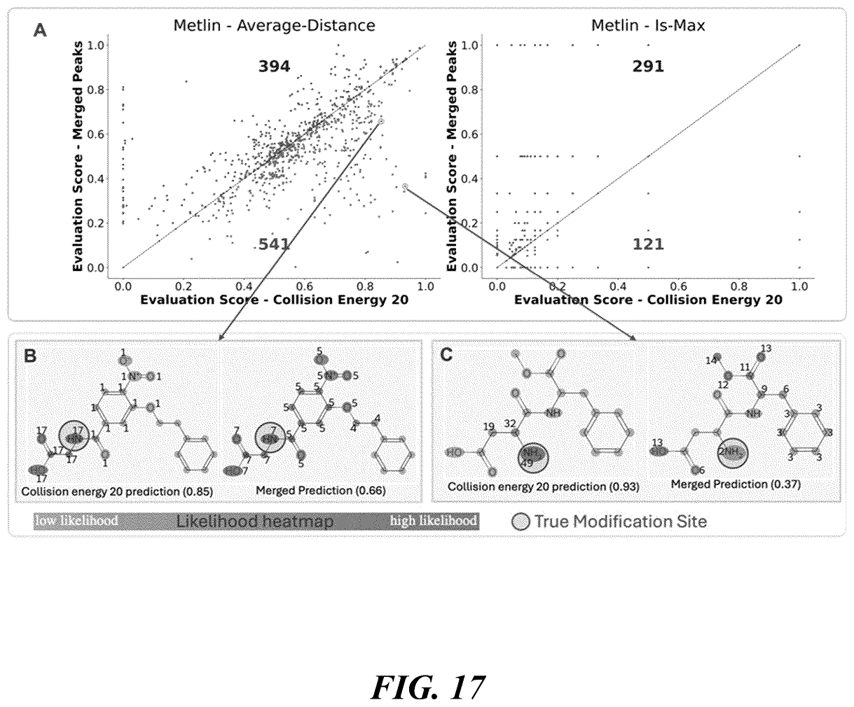

The impact of merging peaks on ModiFinder performance was next evaluated in the example study. FIG. 17 shows that by merging the peaks, the performance of ModiFinder does not improve for all the pairs. In FIG. 17, part A, while the Average-Distance shows no clear advantage on datapoints that had a prediction on collision energy 20 (score above 0), the Is-Max function clearly shows merging the peaks improves the chance of assigning the highest score to the true modification site. FIG. 17, parts B-C show that the newly added peaks provide new information; however, they introduce ambiguities. These ambiguities in some cases will result in a complete miss prediction (FIG. 17, part C), or a more ambiguous prediction resulting in a lower Average-Distance Evaluation score (FIG. 17, part B).

It was hypothesized that multiple collision energies could be complementary in site localization performance. In the example study, MS/MS peaks from different collision energies of the same compound and adduct were merged. To merge two spectra of the same compound acquired with the same adduct but different collision energies, all the peaks from the smaller collision energy spectrum were copied to the aggregate spectra. Then, the peaks of the data with the larger collision energy, for each peak pi, were looped through. It was first checked if there was any peak within 10 ppm of this peak that existed in the aggregate spectra. If there was, the intensity was added to the current intensity. Otherwise, this peak was added to the aggregate spectrum with its original intensity. Finally, the aggregate spectrum was normalized. By naively merging 10, 20, and 40V into a single MS/MS spectrum, no difference was observed in localization performance using the average distance metric (FIG. 15). However, merging MS/MS spectra was shown to improve localization performance over the individual collision energy spectra when using the Is-Max evaluation method from 20V, up to 60 percent (FIG. 15).

This difference is rooted in the underlying construction of these methods. The Average-Distance method takes both ambiguity and proximity into account, while the Is-Max method focuses solely on the highest-scoring atoms in the localization-specifically, identifying the true modification site without considering the ambiguity from other closely scoring atoms scattered across the molecule. As more peaks are annotated, the probability of correctly identifying the modification site increases, leading to higher proximity scores. However, this also flattens the scoring distribution, increasing ambiguity and resulting in only modest changes to the average-distance score. However, the Is-Max method remains largely unaffected by this ambiguity as the additional annotated peaks typically include the true modification site. As a result, the Proximity score mostly increases, leading to a higher overall Is-Max score. This effect can be seen on the scatter plot of FIG. 17, part A, comparing 20V energy and the merged dataset for both scoring methods on the Metlin dataset. FIG. 17, part B shows an example for the case where the Average-Distance decreases but the Is-Max remains the same.

As an alternative approach to merging all energies into a single MS/MS spectrum, the ensemble approach aims to merge the localization predictions of several pairs of MS/MS spectra. Specifically, localization predictions were created for pairs of 10 V, 20 V, and 40 V spectra separately, with the predictions merged in accordance with the following method. In the method, the likelihood predictions from different experiments were combined. To combine the predictions, first a weight was assigned to each prediction. The aggregate likelihood score for each atom was then calculated as the weighted average of its score across the experiments. The weights were chosen two different ways, the first was to assign the same weight to all the experiments, this is the most simple way of combining the predictions. The second method, which proved more effective, assigned weights based on the entropy of the predicted likelihood array. In this approach, higher entropy (indicating more dispersed and less focused predictions) results in lower weights, while lower entropy (indicating more focused predictions) leads to higher weights. The results presented in herein use the entropy-based weighting method, as it generally produces better scores, though the equal-weight method shows a similar overall trend. To report the ensemble results for different collision energies, ModiFinder prediction results from three experiments (using collision energies of 10V, 20V, and 40V) were combined for each matched pair of compounds and adducts. For adducts, the ensemble result was created by merging ModiFinder results from two experiments (positive and negative polarity) for each match. It was observed that this ensemble approach improved the localization performance of ModiFinder on the Is-Max evaluation method by up to 75% compared to its performance on individual collision energy spectra. However, the performance of the Ensemble method on the Average-Distance metric did not surpass that of the individual methods, for reasons similar to those discussed for the merged peaks.

In the example study, Modifinder's performance was compared against its oracle. Comparing ModiFinder's performance, when more experiments and scans are available (merged peaks or ensemble) with its oracle performance on individual sets, demonstrated its potential superiority to the oracle. This suggests that increasing the amount of data can mitigate one of ModiFinder's main Achilles' heels: ambiguity in peak annotation.

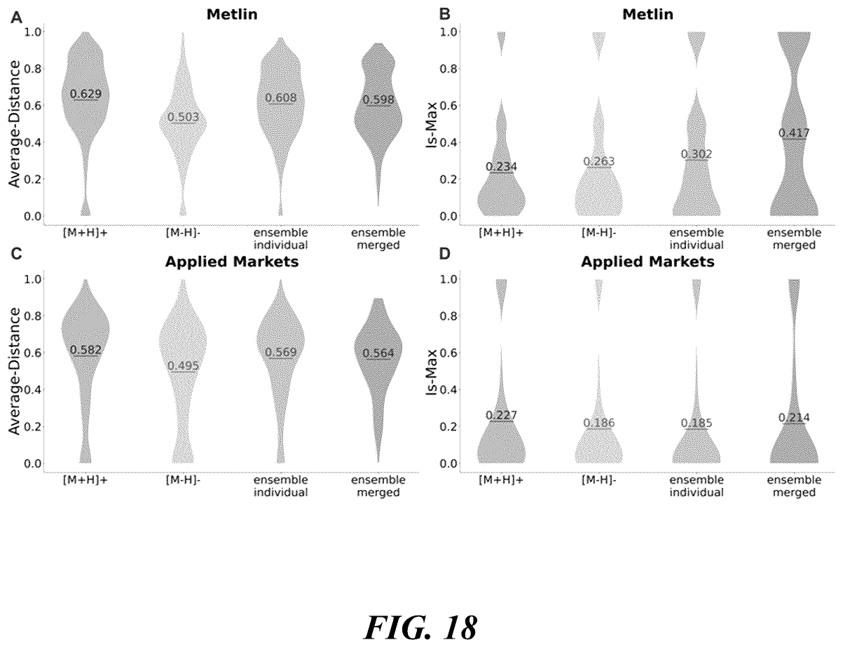

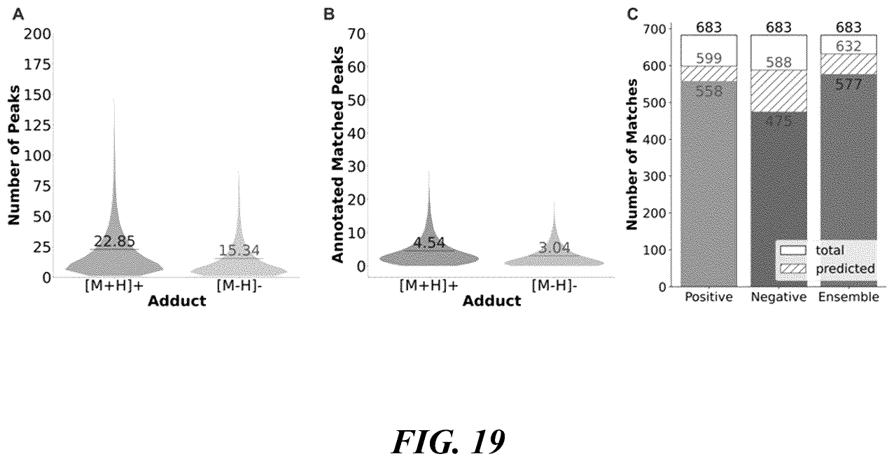

In the example study, complementarity of different adducts in the localization of modification sites with ModiFinder was investigated. Specifically, [M+H] and [M−H] were used as the most prevalent adducts in the dataset. FIG. 18 shows the performance of ModiFinder on each adduct individually and as an ensemble. FIG. 19 shows the distribution of peaks and annotated peaks with respect to Adduct. FIG. 19, part A shows the number of peaks, FIG. 19, part B shows the number of annotated peaks based on the adduct, and FIG. 19, part C shows a plot including color filled bars showing the number of pairs where ModiFinder was able to outperform the random baseline. Out of all 683 pairs of compounds, Positive mode is able to outperform random localization more than Negative mode. Further, the Ensemble approach integrating Positive and Negative increases the number of MS/MS pairs that can improve over random localization. The result of ModiFinder for different adducts shows that ModiFinder performs better on positive mode. “Ensemble Individual” represents the predictions generated by merging results from the same collision energy but different polarities. The “Ensemble Merged” predictions are based on the combined MS/MS spectra from both polarities. Initial evaluation of ModiFinder's performance given [M+H] and [M−H] adducts showed that ModiFinder performs considerably better in positive mode in Average-Distance Metric (FIG. 18). This difference in performance can be attributed in part to the negative mode having fewer peaks and fewer annotated matched peaks (FIG. 19). Although having more annotated matched peaks can sometimes lead to increased ambiguity-hence, not improving the evaluation score-, having fewer than a certain threshold of these peaks means there is less critical information for ModiFinder to utilize effectively.

In the example study, the predictions from [M+H] and [M−H] adducts were combined using the ensemble method. First, each pair of the same collision energy and different polarity were combined to generate a new prediction. The result was reported as the Ensemble Individual in FIG. 18. Then, instead of the individual scans, an aggregate MS/MS was generated using the merge peaks method and then the ensemble prediction was generated using these spectra. Although none of this did improve the evaluation score (FIG. 18), the number of compound pairs where ModiFinder would be applicable increased significantly (FIG. 19, part C). FIG. 19, part C shows a diagram of the number of pairs where ModiFinder was able to outperform the random baseline. Specifically, the positive mode could not provide answers or perform better for 125 pairs, and the negative mode could not provide answers for 208 pairs. After merging the predictions, this number was reduced to 106 pairs, thereby decreasing the space of unanswered pairs by 15%. Additionally, the total number of pairs ModiFinder predicts it can provide reliable info on increases from 599 and 588 (positive and negative mode respectively) to 632. This suggests that in cases where ModiFinder could not accurately annotate the peaks in one polarity mode and provide a reliable answer, there is a chance for it to succeed in the other polarity. Therefore, collecting MS/MS of multiple adducts may not necessarily enhance ModiFinder prediction accuracy for cases already predicted with relatively high confidence (FIG. 18), but these data can extend the coverage to more compounds that initially had low ModiFinder prediction confidence due to a lack of annotated peaks.

Expanding upon the original ModiFinder to add the support for negative adducts, a new module to calculate adducts mass was developed. While there are tools to calculate the adduct mass, such as MSAC, the need to integrate this with other aspects of ModiFinder required developing a module and integrating that with any part of the algorithm that uses the peaks' m/z to assign an annotation or adjusting a formula. This included the refinement by SIRIUS, refinement by msbuddy, and the substructure annotation. For the peak annotation step, when each substructure was created, the mass of the adduct was calculated and the mass of the substructure was adjusted with the calculated mass. Then, the same procedure as the original ModiFinder was taken and peaks within the threshold of the adjusted substructure mass were annotated by that substructure. The supported adducts and their mass are listed as follows: [M+H]+, [M+Na]+, [M−H]−, [M+NH4]+, [M+K]+, [M+Cl]−, [M+Br]−.

In the example study presently described, a subset of a dataset from Agilent Technologies Inc. was utilized. The dataset included compounds that were comprehensively acquired under a consistent and wide range of collision energies and adducts to evaluate ModiFinder site localization performance. This filtered Agilent dataset included 2,150 “Data-Rich” compounds and expanded upon publicly accessible datasets from GNPS by 5 fold, enabling a more comprehensive exploration of the effect of collision energy and adducts on ModiFinder performance.

The findings from the study suggest that increasing the availability of MS/MS spectra from different adducts and energies positively impacts ModiFinder's site localization performance in both MF-R and MF-O modes. Specifically, data acquired under varying adducts appeared to be complementary, allowing ModiFinder to better utilize certain compound pairs, thereby providing previously unavailable information and leading to higher localization evaluation scores. However, this performance improvement is sometimes offset by cases where the additional data either did not contribute significant critical information or increased ambiguity, resulting in lower evaluation scores. Increasing the amount of spectral information from different adducts and energies generally helps ModiFinder maintain its average performance across more compound pairs. However, one way to achieve further performance improvements is to implement drastically different fragmentation mechanisms to enhance ModiFinder's capabilities.

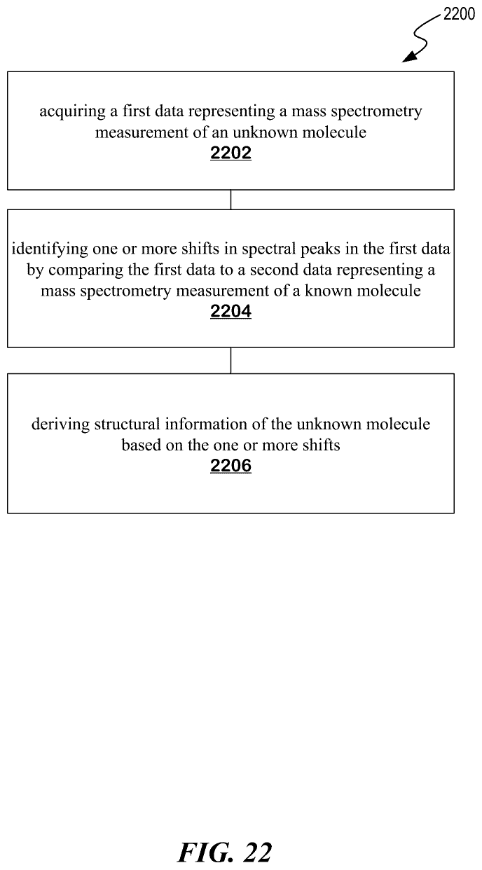

FIG. 22 shows a flow diagram of an example method 2200 of analyzing mass spectrometry data in accordance with the disclosed technology. At operation 2202, the method 2200 includes acquiring a first data representing a mass spectrometry measurement of an unknown molecule. At operation 2204, the method 2200 includes identifying one or more shifts in spectral peaks in the first data by comparing the first data to a second data representing a mass spectrometry measurement of a known molecule. At operation 2206, the method 2200 includes deriving structural information of the unknown molecule based on the one or more shifts.

Some example technical solutions adopted by preferred embodiments that implement techniques described herein include:

1. A method of analyzing mass spectrometry data (e.g., method 2100 depicted in FIG. 21), comprising: acquiring (2102) a first data representing a mass spectrometry measurement of an unknown molecule; identifying (2104) one or more shifts in spectral peaks in the first data by comparing with a second data representing a mass spectrometry measurement of a known molecule; and using (2106) the one or more spectral peaks to derive structural information of the unknown molecule.

2. The method of solution 1, wherein the deriving the structural information includes determining a site of structural modification in the known molecule that results in the unknown molecule.

3. The method of solution 1, wherein the structural information is derived by identifying structural differences between the unknown molecule and the known molecule or one or more additional known molecules in a database.

4. The method of solution 1, wherein the identifying includes: removing spurious peaks by preprocessing the spectral peaks; assigning, for each shift detected between spectral peaks of the first data and the second data, one or more potential substructures underlying the each shift; and deriving the structural information by refining the assignment of the one or more potential substructures.

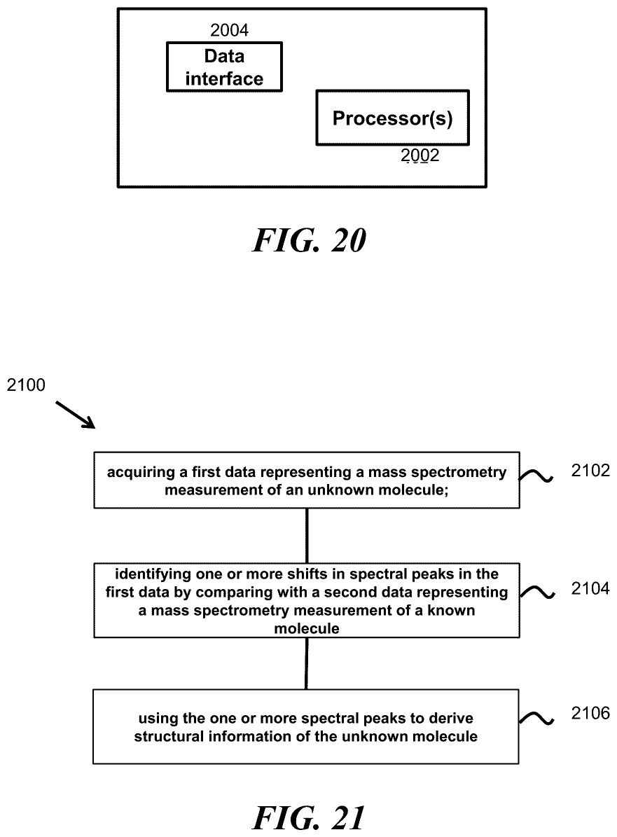

5. An apparatus (e.g., apparatus 2000 depicted in FIG. 20), comprising: one or more processors (2002) configured implement a method recited in any of solutions 1-4. The apparatus 2000 may include a data interface 2004 that allows the one or more processors to read from or write to a memory that may store executable code or a database of known molecular spectrometry data.

6. A system for identifying unknown molecules, comprising: one or more processors configured to implement a method recited in any of solutions 1-4; and a database comprising spectral measurement data of known molecules used as a ground truth by the one or more processors.

7. A computer-readable storage medium having processor-executable code stored thereupon, the code, upon execution, causing at least one processor to implement a method recited in any of solutions 1-4.

8. A system for analyzing mass spectrometry data, comprising: a spectrometer configured to obtain spectral measurement data; and one or more processors configured to receive the spectral measurement data from the spectrometer and to perform a method comprising: acquiring a first data representing a mass spectrometry measurement of an unknown molecule; identifying one or more shifts in spectral peaks in the first data by comparing the first data to a second data representing a mass spectrometry measurement of a known molecule; and deriving structural information of the unknown molecule based on the one or more shifts.

9. The system of solution 8, wherein at least one of the first data or the second data is acquired using the spectrometer.

10. The system of solution 8, wherein the identifying includes: removing spurious peaks by preprocessing the spectral peaks; assigning, for each shift detected between spectral peaks of the first data and the second data, one or more potential substructures underlying the each shift; and deriving the structural information by refining the assignment of the one or more potential substructures.

11. The system of solution 8, wherein deriving the structural information comprises identifying structural differences between the unknown molecule and the known molecule or one or more additional known molecules in a database.

12. The system of solution 8, wherein the structural information comprises a site of structural modification in the unknown molecule.

13. The system of solution 11, wherein the method further comprises: for each atom in the unknown molecule, generating a score indicative of a proximity of the atom to the site of the structural modification by: determining, for each peak in the second data, a set of potential substructures of the known molecule where each of the potential substructures in the set comprises atoms of the known molecule, identifying whether each peak in the second data has a corresponding shifted peak in the first data signifying that at least one of the set of potential substructures includes the site of the structural modification, and increasing or decreasing the score based on results of the identifying.

14. The system of solution 12, wherein the score is increased if the corresponding shifted peak in the first data is identified and decreased if the corresponding shifted peak in the first data is not identified.

15. The system of solution 12, wherein substructures in the set of potential substructures are determined using combinatorial fragmentation.

16. The system of solution 8, wherein the identifying is performed by a trained classifier.

17. The system of solution 8, wherein each of the unknown molecule and the known molecule are of a mass that is between 150 and 2000 Da.

18. A computer program product having code stored thereon, the code, when executed by a processor, causing the processor to implement a method comprising: identifying one or more shifts in spectral peaks in a first data representing a mass spectrometry measurement of an unknown molecule by comparing the first data to a second data representing a mass spectrometry measurement of a known molecule; determining, for each shift detected between spectral peaks of the first data and the second data, one or more potential substructures underlying the each shift; computing a distribution of likelihood scores indicating likelihood of each atom in the known molecule to be a site of structural modification in the unknown molecule; and using the distribution to localize the site of structural modification to at least one of the one or more potential substructures.

19. The computer program product of solution 18, wherein the method further comprises: obtaining a predicted molecular formula associated with each of the spectral peaks, and using the predicted molecular formula to remove spurious potential substructures from the one or more potential substructures.

20. The computer program product of solution 18, wherein each of the likelihood scores in the distribution is based on a proximity of each atom in the known molecule to the site of structural modification.

21. The computer program product of solution 18, wherein the method further comprises: providing a visualization of the one or more potential substructures, wherein the visualization includes visualization of atomic sites associated with each of the one or more potential substructures, and wherein the distribution of likelihood scores is represented in the visualization.

22. The computer program product of solution 18, wherein the determining comprises: obtaining structural information of one or more additional molecules exhibiting structural similarity to the known molecule from a database, and using the structural information to refine the one or more potential substructures.

23. The computer program product of solution 18, wherein the identifying includes: removing spurious peaks by preprocessing the spectral peaks; and deriving structural information of the unknown molecule by refining the one or more potential substructures.

24. The computer program product of solution 18, wherein the one or more potential substructures are determined using combinatorial fragmentation.

25. The computer program product of solution 18, wherein the identifying is performed by a trained classifier.

26. The computer program product of solution 18, wherein the method further comprises: refining the distribution of likelihood scores using an evaluation metric, wherein the evaluation metric is based on proximities of atoms in the known molecule to the site of the structural modification and identifying atoms in the known molecule that have similar likelihood scores.

27. The computer program product of solution 18, wherein each likelihood score in the distribution is based on identifying whether each peak in the second data has a corresponding shifted peak in the first data signifying that at least one of the one or more potential substructures includes the site of the structural modification.

Techniques described in the present document may be implemented as the following solutions by some preferred embodiments.

It should be noted that the methods described above describe possible implementations, and that the operations and the steps may be rearranged or otherwise modified and that other implementations are possible. Furthermore, embodiments from two or more of the methods may be combined.

From the foregoing, it will be appreciated that specific embodiments of the invention have been described herein for purposes of illustration, but that various modifications may be made without deviating from the scope of the invention. Rather, in the foregoing description, numerous specific details are discussed to provide a thorough and enabling description for embodiments of the present technology. One skilled in the relevant art, however, will recognize that the disclosure can be practiced without one or more of the specific details. In other instances, well-known structures or operations often associated with memory systems and devices are not shown, or are not described in detail, to avoid obscuring other aspects of the technology. In general, it should be understood that various other devices, systems, and methods in addition to those specific embodiments disclosed herein may be within the scope of the present technology.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

Only a few implementations and examples are described and other implementations, enhancements and variations can be made based on what is described and illustrated in this patent document.

1. A system for analyzing mass spectrometry data, comprising:
a spectrometer configured to obtain spectral measurement data; and
one or more processors configured to receive the spectral measurement data from the spectrometer and to perform a method comprising:
acquiring a first data representing a mass spectrometry measurement of an unknown molecule;
identifying one or more shifts in spectral peaks in the first data by comparing the first data to a second data representing a mass spectrometry measurement of a known molecule; and
deriving structural information of the unknown molecule based on the one or more shifts.

2. The system of claim 1, wherein at least one of the first data or the second data is acquired using the spectrometer.

3. The system of claim 1, wherein the identifying includes:
removing spurious peaks by preprocessing the spectral peaks;
assigning, for each shift detected between spectral peaks of the first data and the second data, one or more potential substructures underlying the each shift; and
deriving the structural information by refining the assignment of the one or more potential substructures.

4. The system of claim 1, wherein deriving the structural information comprises identifying structural differences between the unknown molecule and the known molecule or one or more additional known molecules in a database.

5. The system of claim 1, wherein the structural information comprises a site of structural modification in the unknown molecule.

6. The system claim 5, wherein the method further comprises:
for each atom in the unknown molecule, generating a score indicative of a proximity of the atom to the site of the structural modification by:
determining, for each peak in the second data, a set of potential substructures of the known molecule where each of the potential substructures in the set comprises atoms of the known molecule,
identifying whether each peak in the second data has a corresponding shifted peak in the first data signifying that at least one of the set of potential substructures includes the site of the structural modification, and
increasing or decreasing the score based on results of the identifying.

7. The system of claim 6, wherein the score is increased if the corresponding shifted peak in the first data is identified and decreased if the corresponding shifted peak in the first data is not identified.

8. The system of claim 1, wherein the identifying is performed by a trained classifier.

9. The system of claim 1, wherein each of the unknown molecule and the known molecule are of a mass that is between 150 and 2000 Da.

10. A computer program product having code stored thereon, the code, when executed by a processor, causing the processor to implement a method comprising:
identifying one or more shifts in spectral peaks in a first data representing a mass spectrometry measurement of an unknown molecule by comparing the first data to a second data representing a mass spectrometry measurement of a known molecule;
determining, for each shift detected between spectral peaks of the first data and the second data, one or more potential substructures underlying the each shift;
computing a distribution of likelihood scores indicating likelihood of each atom in the known molecule to be a site of structural modification in the unknown molecule; and
using the distribution to localize the site of structural modification to at least one of the one or more potential substructures.

11. The computer program product of claim 10, wherein the method further comprises:
obtaining a predicted molecular formula associated with each of the spectral peaks, and
using the predicted molecular formula to remove spurious potential substructures from the one or more potential substructures.

12. The computer program product of claim 10, wherein each of the likelihood scores in the distribution is based on a proximity of each atom in the known molecule to the site of structural modification.

13. The computer program product of claim 10, wherein the method further comprises:
providing a visualization of the one or more potential substructures,
wherein the visualization includes visualization of atomic sites associated with each of the one or more potential substructures, and
wherein the distribution of likelihood scores is represented in the visualization.

14. The computer program product of claim 10, wherein the determining comprises:
obtaining structural information of one or more additional molecules exhibiting structural similarity to the known molecule from a database, and
using the structural information to refine the one or more potential substructures.

15. The computer program product of claim 10, wherein the identifying includes:
removing spurious peaks by preprocessing the spectral peaks; and
deriving structural information of the unknown molecule by refining the one or more potential substructures.

16. The computer program product of claim 10, wherein the one or more potential substructures are determined using combinatorial fragmentation.

17. The computer program product of claim 10, wherein the identifying is performed by a trained classifier.

18. The computer program product of claim 10, wherein the method further comprises:
refining the distribution of likelihood scores using an evaluation metric,
wherein the evaluation metric is based on proximities of atoms in the known molecule to the site of the structural modification and identifying atoms in the known molecule that have similar likelihood scores.

19. The computer program product of claim 10, wherein each likelihood score in the distribution is based on identifying whether each peak in the second data has a corresponding shifted peak in the first data signifying that at least one of the one or more potential substructures includes the site of the structural modification.

20. A computer-implemented method for analyzing mass spectrometry data, comprising acquiring a first data representing a mass spectrometry measurement of an unknown
molecule;
identifying one or more shifts in spectral peaks in the first data by comparing the first data to a second data representing a mass spectrometry measurement of a known molecule; and
deriving structural information of the unknown molecule based on the one or more shifts.
